(19) United States
(12) Patent Application Publication
(10) Pub. No.: US 2025/0324456 A1
(43) Pub. Date: Oct. 16, 2025

(54) EARLY TIMING ADVANCE ACQUISITION FOR MOBILITY PROCEDURES

(71) Applicant: QUALCOMM Incorporated, San Diego, CA (US)

(72) Inventors: Naeem AKL, BRIDGEWATER, NJ (US); Prasada Veera Reddy KADIRI, San Diego, CA (US); Punyaslok PURKAYASTHA, San Diego, CA (US); Jelena DAMNJANOVIC, Del Mar, CA (US); Shankar KRISHNAN, Poway, CA (US)

(21) Appl. No.: 18/633,383

(22) Filed: Apr. 11, 2024

(51) Int. Cl. H04W 74/0833; H04W 56/00

(52) U.S. Cl. CPC H04W 74/0833; H04W 56/0045

(57) ABSTRACT

Methods, systems, and devices for wireless communications are described. A target network entity may obtain a request for one or more random access resources associated with a candidate cell served by the target network entity. The target network entity may output a random access resource configuration indicating the one or more random access resources and the candidate cell based on the request. The one or more random access resources may be associated with a partition at a source network entity. The target network entity may obtain a random access message via one of the one or more random access resources indicated by the random access resource configuration.

### FIELD OF TECHNOLOGY

The following relates to wireless communications, including early timing advance acquisition for mobility procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support early timing advance acquisition for mobility procedures. For example, the described techniques provide for obtaining, at a target network entity, a request for one or more random access resources associated with a candidate cell served by the target network entity. The target network entity may output a random access resource configuration indicating the one or more random access resources and the candidate cell based on the request. The one or more random access resources may be associated with a partition at a source network entity. The target network entity may obtain a random access message via one of the one or more random access resources indicated by the random access resource configuration.

A method for wireless communication by a target network entity is described. The method may include obtaining a request for one or more random access resources associated with a candidate cell served by the target network entity, outputting a random access resource configuration indicating the one or more random access resources and the candidate cell based on the request, where the one or more random access resources are associated with a partition at a source network entity, and obtaining a random access message via one of the one or more random access resources indicated by the random access resource configuration.

A target network entity for wireless communication is described. The target network entity may include one or more memories storing processor executable code, and one or more processors coupled with the one or more memories. The one or more processors may individually or collectively be operable to execute the code to cause the target network entity to obtain a request for one or more random access resources associated with a candidate cell served by the target network entity, output a random access resource configuration indicating the one or more random access resources and the candidate cell based on the request, where the one or more random access resources are associated with a partition at a source network entity, and obtain a random access message via one of the one or more random access resources indicated by the random access resource configuration.

Another target network entity for wireless communication is described. The target network entity may include means for obtaining a request for one or more random access resources associated with a candidate cell served by the target network entity, means for outputting a random access resource configuration indicating the one or more random access resources and the candidate cell based on the request, where the one or more random access resources are associated with a partition at a source network entity, and means for obtaining a random access message via one of the one or more random access resources indicated by the random access resource configuration.

A non-transitory computer-readable medium storing code for wireless communication is described. The code may include instructions executable by one or more processors to obtain a request for one or more random access resources associated with a candidate cell served by the target network entity, output a random access resource configuration indicating the one or more random access resources and the candidate cell based on the request, where the one or more random access resources are associated with a partition at a source network entity, and obtain a random access message via one of the one or more random access resources indicated by the random access resource configuration.

Some examples of the method, target network entities, and non-transitory computer-readable medium described herein may further include operations, features, means, or instructions for performing a mobility procedure of a user equipment (UE) from the source network entity to the target network entity in response to obtaining the random access message.

In some examples of the method, target network entities, and non-transitory computer-readable medium described herein, output, to the source network entity, a timing advanced (TA) value associating with the UE based on the random access message, where the mobility procedure may be based on the TA value.

In some examples of the method, target network entities, and non-transitory computer-readable medium described herein, the random access resource configuration includes a UE identifier, a candidate cell identifier associated with the candidate cell, lower-layer triggered mobility (LTM) candidate configuration information, a mobility command, or a combination thereof.

In some examples of the method, target network entities, and non-transitory computer-readable medium described herein, obtaining the request for one or more random access resources may include operations, features, means, or instructions for obtaining, at a central unit (CU) of the target network entity, the request for the one or more random access resources.

In some examples of the method, target network entities, and non-transitory computer-readable medium described herein, output, by the CU of the target network entity, a second request for one or more random access resources associating with one or more distributed units (DUs) of the target network entity to the one or more DUs of the target network entity based on the request for one or more random access resources, where the second request includes an identifier associated with the source network entity, an identifier associated with a DU associated with the source network entity an identifier associated with a cell served by the source network entity, a virtual identifier corresponding to a virtual DU associated with the source network entity, or a combination thereof.

Some examples of the method, target network entities, and non-transitory computer-readable medium described herein may further include operations, features, means, or instructions for obtaining, from the one or more DUs by the CU of the target network entity, an indication of the random access resource configuration based on outputting the second request to the one or more DUs of the target network entity, where outputting the random access resource configuration includes outputting, by the CU of the target network entity, the random access resource configuration indicating the one or more random access resources associated with the one or more DUs based on obtaining the random access resource configuration from the one or more DUs.

In some examples of the method, target network entities, and non-transitory computer-readable medium described herein, the indication of the random access resource configuration obtain from the one or more DUs includes, an identifier associated with the source network entity, a DU identifier associated with the source network entity, an identifier associated with a cell served by the source network entity, a virtual identifier corresponding to a virtual DU associated with the source network entity, or a combination thereof.

In some examples of the method, target network entities, and non-transitory computer-readable medium described herein, obtaining the random access message may include operations, features, means, or instructions for obtaining, at one or more DUs of the target network entity, the random access message via one of the one or more random access resources indicated by the random access resource configuration.

In some examples of the method, target network entities, and non-transitory computer-readable medium described herein, output, by the one or more DUs to a CU of the target network entity, an indication of a TA value corresponding to the random access message, the indication of the TA value including an ID associated with the source network entity, a DU identifier associated with the source network entity, an identifier associated with a cell served by the source network entity, a network entity identifier indicated in the request for the one or more random access resources, or a combination thereof.

In some examples of the method, target network entities, and non-transitory computer-readable medium described herein, a message including the random access resource configuration may include operations, features, means, or instructions for a list of one or more cell identifiers, a set of random access resources include the one or more random access resources, a user identifier, a cell identifier associated with the target network entity, an LTM candidate configuration, a handover command, a list of DU identifiers corresponding to DUs corresponding to the source network entity, a list of cell identifiers corresponding to cells served by the source network entity, or any combination thereof.

In some examples of the method, target network entities, and non-transitory computer-readable medium described herein, the message including the random access resource configuration further includes an indication of an association between the set of random access resources and a respective cell identifier of the list of cell identifiers or respective DU identifier of the list of DU identifiers.

Some examples of the method, target network entities, and non-transitory computer-readable medium described herein may further include operations, features, means, or instructions for partitioning the one or more random access resources into a first set of random access resources and a second set of random access resources, where the random access resource configuration includes an indication of the partitioning at the target network entity, and where the first set of random access resources includes a first set of one or more random access preambles, and the second set of random access resources includes a second set of one or more random access preambles.

Some examples of the method, target network entities, and non-transitory computer-readable medium described herein may further include operations, features, means, or instructions for partitioning the one or more random access resources into a first set of random access resources and a second set of random access resources, where the random access resource configuration includes an indication of the partitioning at the target network entity, and where the first set of random access resources includes a first set of one or more random access occasions (ROs), and the second set of random access resources includes a second set of one or more ROs.

In some examples of the method, target network entities, and non-transitory computer-readable medium described herein, the request includes an indication that the one or more random access resources correspond to an uplink synchronization procedure between a UE served by the source network entity and the candidate cell served by the target network entity, the synchronization procedure to occur prior to triggering a mobility procedure of the UE from the source network entity to the target network entity.

A method for wireless communication by a source network entity is described. The method may include outputting a request for one or more random access resources associated with a candidate cell served by a target network entity, obtaining a random access resource configuration indicating the one or more random access resources and the candidate cell based on the request, where the one or more random access resources are associated with a partition at the source network entity, and outputting a control message to a UE indicating a random access resource of the one or more random access resources associated with the random access resource configuration.

A source network entity for wireless communication is described. The source network entity may include one or more memories storing processor executable code, and one or more processors coupled with the one or more memories. The one or more processors may individually or collectively be operable to execute the code to cause the source network entity to output a request for one or more random access resources associated with a candidate cell served by a target network entity, obtain a random access resource configuration indicating the one or more random access resources and the candidate cell based on the request, where the one or more random access resources are associated with a partition at the source network entity, and output a control message to a UE indicating a random access resource of the one or more random access resources associated with the random access resource configuration.

Another source network entity for wireless communication is described. The source network entity may include means for outputting a request for one or more random access resources associated with a candidate cell served by a target network entity, means for obtaining a random access resource configuration indicating the one or more random access resources and the candidate cell based on the request, where the one or more random access resources are associated with a partition at the source network entity, and means for outputting a control message to a UE indicating a random access resource of the one or more random access resources associated with the random access resource configuration.

A non-transitory computer-readable medium storing code for wireless communication is described. The code may include instructions executable by one or more processors to output a request for one or more random access resources associated with a candidate cell served by a target network entity, obtain a random access resource configuration indicating the one or more random access resources and the candidate cell based on the request, where the one or more random access resources are associated with a partition at the source network entity, and output a control message to a UE indicating a random access resource of the one or more random access resources associated with the random access resource configuration.

In some examples of the method, source network entities, and non-transitory computer-readable medium described herein, obtaining the random access resource configuration may include operations, features, means, or instructions for obtaining, at a CU of the source network entity, the random access resource configuration indicating the one or more random access resources associated with one or more DUs of the source network entity.

In some examples of the method, source network entities, and non-transitory computer-readable medium described herein, output, by the CU of the source network entity to a DU of one or more DUs of the source network entity, a second random access resource configuration indicating a set of one or more random access resources associated with the DU.

Some examples of the method, source network entities, and non-transitory computer-readable medium described herein may further include operations, features, means, or instructions for obtaining, at a CU of the source network entity from a CU of the target network entity, an indication of a TA value corresponding to a random access message transmitted by the UE and an indication of a random access resource associated with the random access message, where the UE may be served by a DU of the source network entity and output, by the CU of the source network entity to the DU of the source network entity, the TA value based at least in part on the random access resource being associated with the DU of the source network entity, where a mobility procedure may be based on the TA value.

### BRIEF DESCRIPTION OF THE DRAWINGS

FIG. 1 shows an example of a wireless communications system that supports early timing advance acquisition for mobility procedures in accordance with one or more aspects of the present disclosure.

FIG. 2 shows an example of a network architecture that supports early timing advance acquisition for mobility procedures in accordance with one or more aspects of the present disclosure.

FIG. 3 shows an example of a wireless communications system that supports early timing advance acquisition for mobility procedures in accordance with one or more aspects of the present disclosure.

FIG. 4 shows an example of a wireless communications system that supports early timing advance acquisition for mobility procedures in accordance with one or more aspects of the present disclosure.

FIG. 5 shows an example of a process flow that supports early timing advance acquisition for mobility procedures in accordance with one or more aspects of the present disclosure.

FIG. 6 shows an example of a process flow that supports early timing advance acquisition for mobility procedures in accordance with one or more aspects of the present disclosure.

FIGS. 7 and 8 show block diagrams of devices that support early timing advance acquisition for mobility procedures in accordance with one or more aspects of the present disclosure.

FIG. 9 shows a block diagram of a communications manager that supports early timing advance acquisition for mobility procedures in accordance with one or more aspects of the present disclosure.

FIG. 10 shows a diagram of a system including a device that supports early timing advance acquisition for mobility procedures in accordance with one or more aspects of the present disclosure.

FIGS. 11 and 12 show block diagrams of devices that support early timing advance acquisition for mobility procedures in accordance with one or more aspects of the present disclosure.

FIG. 13 shows a block diagram of a communications manager that supports early timing advance acquisition for mobility procedures in accordance with one or more aspects of the present disclosure.

FIG. 14 shows a diagram of a system including a device that supports early timing advance acquisition for mobility procedures in accordance with one or more aspects of the present disclosure.

FIGS. 15 through 19 show flowcharts illustrating methods that support early timing advance acquisition for mobility procedures in accordance with one or more aspects of the present disclosure.

### DETAILED DESCRIPTION

In some wireless communications systems, a source network entity communicating with a user equipment (UE) via a first cell may perform a mobility procedure to handover the UE to a second network entity associated with a candidate cell (e.g., a target cell for the handover procedure). In some cases, the mobility procedure may include a random access channel (RACH) procedure. The RACH procedure may provide uplink synchronization information to the UE (e.g., a timing advanced (TA) value associated with communication between the UE and the candidate cell). During the RACH procedure, the UE may spend a relatively large amount of time without transmitting any data traffic to the UE. Specifically, the UE may experience a latency associated with determining the TA value. In other words, the RACH procedure may be associated with a high latency at the UE. To reduce latency, the source network entity and the target network entity may perform a lower-layer triggered mobility (LTM) procedure. The LTM procedure may be associated with a lower latency at the UE. In order to perform the LTM procedure, the source network entity, the target network entity, and the UE may communicate to perform a RACH-less handover procedure. For example, the UE, the source network entity, and the target network entity, may participate in an early RACH procedure including transmission of a single RACH message to the target network entity for generation of the TA value prior to performing the LTM procedure, and providing the TA value to the source network entity for use by the UE during a subsequent mobility procedure.

In some examples, one or both of the network entities may support a split architecture (e.g., performing wireless communications via a central unit (CU) and one or more distributed units (DUs). In some cases, the TA value determined for the RACH-less handover may be associated with the UE based on the previously transmitted RACH message. For example, the RACH message transmitted by the UE may be associated with a unique RACH preamble ID. The DU at the target network entity may associate the TA value with the UE based on the unique RACH preamble. In some cases, the target network entity may communicate with multiple UEs. Reserving RACH resources (e.g., unique RACH preambles or unique random access occasions (ROs)) for the purpose of low level mobility procedures (e.g., LTM) per UE for a long period of time may result in a large overhead for each candidate cell (e.g., the DU at the target network entity). But, if the low level mobility procedure uses shared RACH-resources, when the DU at the target network entity computes the TA value, the DU may not be able to identity the UE associated with the TA value. For example, the DU at the target network entity, or the CU of the target network entity, may not be able to determine to which device to forward the calculated TA value.

According to techniques described herein, RACH resources may be partitioned by network entities (e.g., which may or may not support split architectures), and the network entities may coordinate RACH resource information to effectively map calculated TA values to the appropriate UEs, which may subsequently perform RACH-less mobility procedures according to the calculated TA values (e.g., without the increased overhead for each candidate cell, and without the confusion of shared RACH resources). For example, the source network entity may transmit a request for one or more RACH resources associated with the candidate cell. The target network entity may transmit a RACH resource configuration indicating a set of one or more RACH resources. The source network entity may internally partition the set of one or more RACH resources between one or more UEs, one or more distributed units (DUs), or one or more cells (e.g., may associate different UEs, DUs, or cells with respective RACH resources). The source network entity may transmit an indication of a RACH resource to the UE. The UE may transmit a RACH message via the indicated RACH resources associated with the candidate cell. The target network entity may calculate a TA value associated with the UE based on the RACH message. The target network entity may transmit the TA value and an indication of the RACH resource associated with the TA value to the source network entity. The source network entity may forward the TA value to the UE based on the indicated RACH resource and the association between different UEs, DUs, or cells and the indicated RACH resource. For example, the RACH resource may be associated with a DU of the source network entity based on the internal partitioning performed at the source network entity. The source network entity may provide the TA value to the UE during the LTM procedure. The UE may subsequently utilize the indicated TA value for the handover procedure (e.g., without performing an additional or multi-step RACH procedure). The early RACH procedure may reduce the latency associated with the mobility procedure at the UE, increase throughput, decrease system latency, increase system efficiency, and improve user experience.

Aspects of the disclosure are initially described in the context of wireless communications systems. Aspects of the disclosure are further illustrated by and described with reference to apparatus diagrams, system diagrams, and flowcharts that relate to early TA acquisition for mobility procedures.

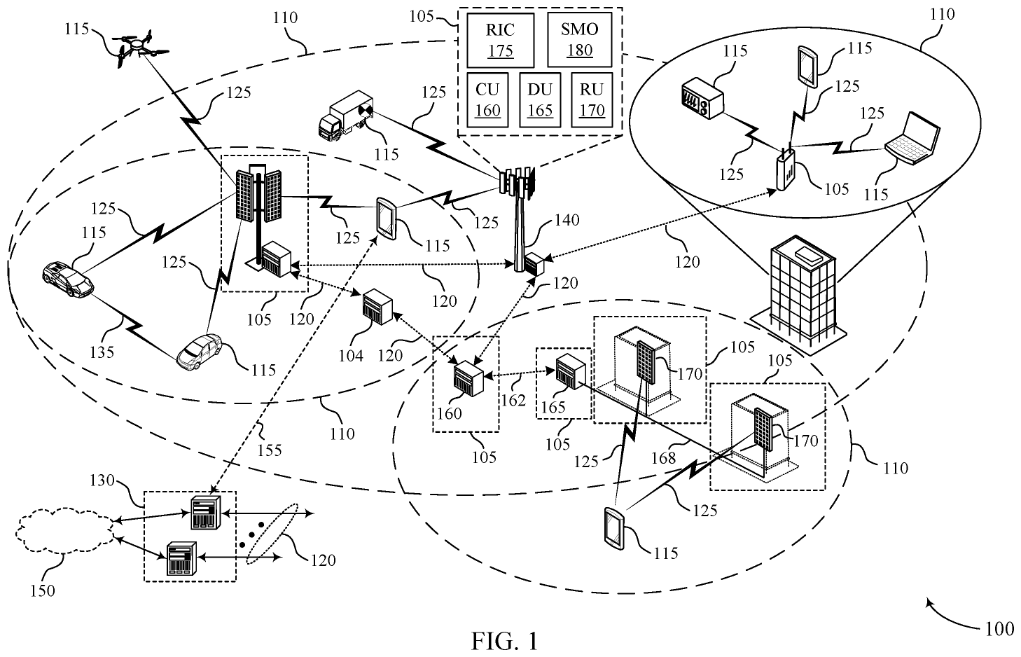

FIG. 1 shows an example of a wireless communications system 100 that supports early TA acquisition for mobility procedures in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a DU, such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

According to techniques described herein, the source network entity 105 and the target network entity 105 may perform a LTM procedure. The LTM procedure may be associated with a lower latency at the UE 115. In order to perform the LTM procedure, the source network entity 105, the target network entity 105, and the UE 115 may communicate to perform an early RACH procedure to generate and forward the TA value prior to performing the LTM procedure. For example, the source network entity 105 may transmit a request for one or more RACH resources associated with the candidate cell. The target network entity 105 may transmit a RACH resource configuration indicating a set of one or more RACH resources. The source network entity 105 may internally partition the set of one or more RACH resources between one or more UEs 115 one or more DUs 165, or one or more cells (e.g., associate different UEs 115, DUs 165, or cells with respective RACH resources). The source network entity 105 may transmit an indication of a RACH resource to the UE 115. The UE 115 may transmit a RACH message via the indicated RACH resources associated with the candidate cell. The target network entity 105 may calculate a TA value associated with the UE 115 based on the RACH message. The target network entity 105 may transmit the TA value and an indication of the RACH resource associated with the TA value to the source network entity 105. The source network entity 105 may forward the TA value based on the indicated RACH resource and the association between different UEs 115, DUs 165, or cells and the indicated RACH resource. The source network entity 105 may provide the TA value to the UE 115 during the LTM procedure. The early RACH may reduce the latency associated with the mobility procedure at the UE 115.

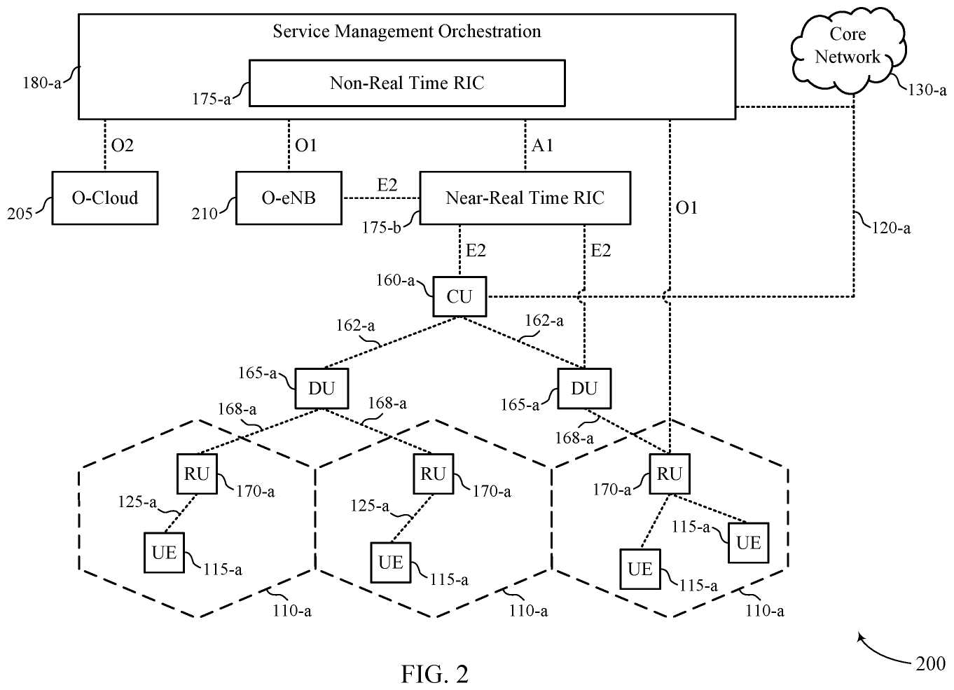

FIG. 2 shows an example of a network architecture 200 (e.g., a disaggregated base station architecture, a disaggregated RAN architecture) that supports early TA acquisition for mobility procedures in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical RACH (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

According to techniques described herein, the source network entity 105 and the target network entity 105 may perform a LTM procedure. The LTM procedure may be associated with a lower latency at the UE 115. In order to perform the LTM procedure, the source network entity 105, the target network entity 105, and the UE 115 may communicate to perform an early RACH procedure to generate and forward the TA value prior to performing the LTM procedure. For example, the source network entity 105 may transmit a request for one or more RACH resources associated with the candidate cell. The target network entity 105 may transmit a RACH resource configuration indicating a set of one or more RACH resources. The source network entity 105 may internally partition the set of one or more RACH resources between one or more UEs 115, one or more DUs 165, or one or more cells (e.g., associate different UEs 115, DUs 165, or cells with respective RACH resources). The source network entity 105 may transmit an indication of a RACH resource to the UE 115. The UE 115 may transmit a RACH message via the indicated RACH resources associated with the candidate cell. The target network entity 105 may calculate a TA value associated with the UE 115 based on the RACH message. The target network entity 105 may transmit the TA value and an indication of the RACH resource associated with the TA value to the source network entity 105. The source network entity 105 may forward the TA value based on the indicated RACH resource and the association between different UEs 115, DUs 165, or cells and the indicated RACH resource. The source network entity 105 may provide the TA value to the UE 115 during the LTM procedure. The early RACH may reduce the latency associated with the mobility procedure at the UE 115.

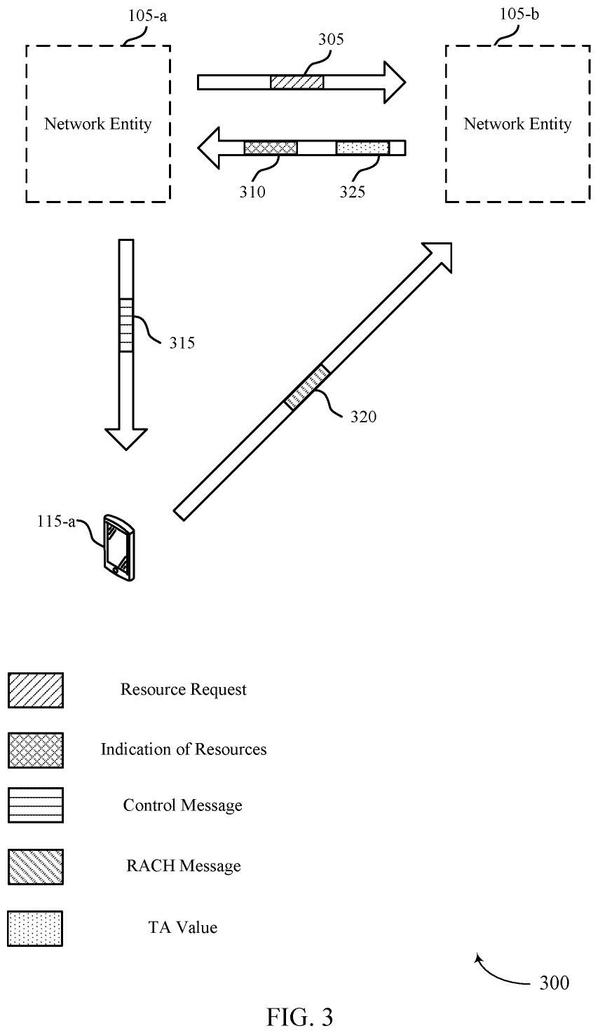

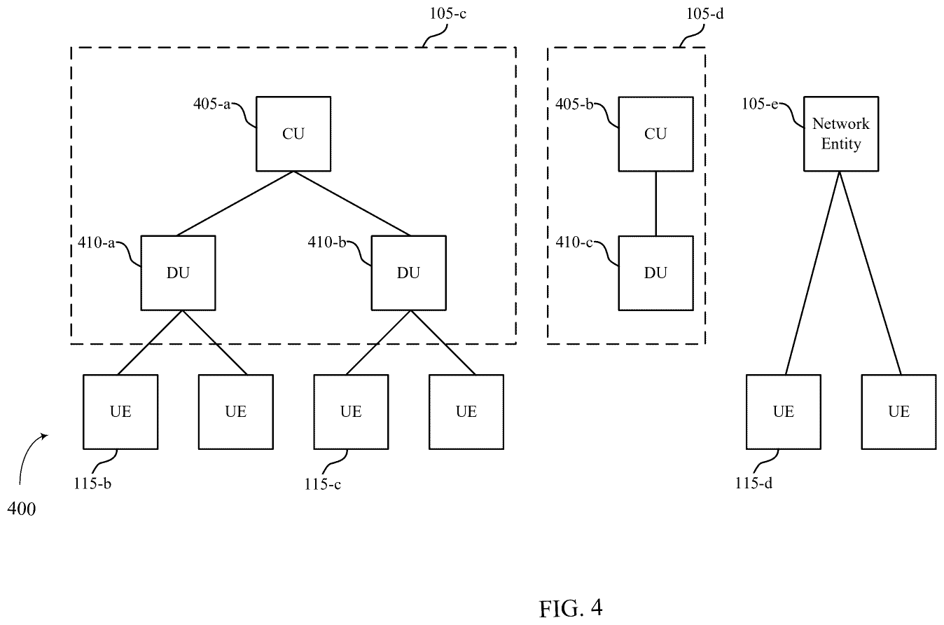

FIG. 3 shows an example of a wireless communications system 300 that supports early TA acquisition for mobility procedures in accordance with one or more aspects of the present disclosure. In some examples, wireless communications system 300 may implement aspects of wireless communications system 100 and the network architecture 200. For example, a UE 115-a may represent an example of a UE, such as the UEs 115 described with reference to FIG. 1. The source network entity 105-a and the target network entity 105-b may represent an example of a network entity, such as the network entity 105 described with reference to FIG. 1 and FIG. 2. In some cases, the source network entity 105-a and the target network entity 105-b may include a CU and one or more DUs (the CU and one or more DUs are not shown in FIG. 3), as described with reference to FIGS. 2 and 4.

In some wireless communications systems, a UE 115-a may be configured to perform a low level mobility procedure (e.g., a L1 and L2 mobility procedure or a RACH-less LTM cell switch procedure) to switch cells (e.g., intra-gNB LTM procedures, where the UE switches from a first cell served by a first DU of the network entity 105-a to a second cell served by a second DU of the network entity 105-a, where the first and second DU are associated with a single CU). During a low level mobility procedure, the UE 115-a may transmit L1 measurements to a source network entity 105-a (e.g., a first DU associated with the source network entity 105-a). The UE 115-a may receive a control message (e.g., a MAC control element (MAC-CE)) indicating for the UE 115-a to switch cells within the network entity 105-a (e.g., to a second DU corresponding to the same CU). In some cases, the UE 115-a may perform a low level mobility procedure to reduce interruption or delay during the mobility procedure (e.g., a hand over procedure) compared to a high level mobility procedure (e.g., an L3 mobility procedure). The low level mobility procedure may be associated with reduction in a delay compared to the high level mobility procedure based on skipping a RACH procedure during the low level mobility procedure. The UE 115-a may perform an early RACH procedure (e.g., an uplink synchronization procedure) prior to a low level mobility procedure. That is, the UE 115-a may perform a low level mobility procedure without performing a RACH procedure based on the UE 115-a performing an early RACH procedure (e.g., which may be referred to as a one-step RACH or a single-step RACH procedure) prior to the low level mobility procedure.

For example, the low level mobility procedure may be based on a TA value associated with a target cell. The source network entity 105 (e.g., the first DU of the network entity 105-a) may acquire the TA value prior to the low level mobility procedure. In some cases, the UE 115-a may calculate the TA value. In some other cases, the UE 115-a may receive a physical downlink control channel (PDCCH) order to perform an early RACH procedure (e.g., PDCCH-ordered RACH).

The UE 115-a may perform an early RACH procedure with the source network entity 105-a. For example, a first DU at the source network entity 105-a may transmit a control message (e.g., via PDCCH) to the UE 115-a indicating for the UE 115-a to transmit a RACH message (e.g., an initial RACH message, a RACH message one, or a one-step RACH message) to a candidate cell associated with a second DU of the network entity 105-a. The second DU of the network entity 105-a may calculate a TA value based on the RACH message. The TA value may indicate an amount of time prior to a time boundary at which the UE 115-a is to transmit uplink signaling to arrive at a corresponding timing at the receiving network entity 105. The TA value may be an offset the UE 115-a may apply for subsequent uplink communications at the candidate cell (e.g., if the UE 115-a performs a low level mobility procedure to switch to the candidate cell). The second DU may forward the TA value associated with the candidate cell to a CU of the network entity 105-a, and the CU may forward the TA value associated with the candidate cell to the first DU. The first DU may store the TA value until the first DU determines to output a handover command (e.g., an indication for the UE 115-a to perform the low level mobility procedure) based on L1 measurements from the UE 115-a. The handover command (e.g., the LTM Cell switch MAC CE) may include the TA value. The UE 115-a may switch to the candidate cell (e.g., served by the second DU of the network entity 105-a) based on receiving the TA value and refrain from performing a RACH procedure during the low level mobility procedure.

In some cases, the TA value may be associated with the UE 115-a based on the previously transmitted RACH message. For example, the RACH message transmitted by the UE 115-a may be associated with a unique RACH preamble ID. The second DU may associate the TA value with the UE 115-a based on the unique RACH preamble. In some cases, the network entity 105-a may communicate with a plurality of UEs 115. Reserving RACH resources for the purpose of low level mobility procedures (e.g., LTM) per UE for a long period of time may result in a large overhead for the candidate cell (e.g., the second DU). If the low level mobility procedure uses shared RACH-resources, when the second DU computes the TA value the second DU may be unable to identity the UE 115 associated with the TA value. For example, the second DU or the CU of the network entity 105-a may not be able to determine to which device to forward the TA value.

According to techniques described herein, to reduce such overhead for the candidate cell, the candidate cell may partition RACH-resources (e.g., RACH preambles, RACH preamble IDs, RACH occasions, or RACH occasion information) of a candidate cell (e.g., per serving DU). The partitioned RACH resources may enable sharing of RACH resources among the UEs 115 served by same DU, which may reduce the overhead (e.g., the RACH overhead) for the candidate cell. The RACH resources may also be used for other purposes (e.g., system information acquisition, L3 mobility, resynchronization).

For example, the CU of the network entity 105-a may output (e.g., to the second DU) a request for RACH resources of the candidate cell including a first DU ID associated with the first DU. The second DU may output (e.g., to the CU) an indication of one or more RACH resources of the candidate cell associated with the first DU. The CU may output (e.g., to the first DU served by the CU) an indication of the one or more RACH resources of the candidate cell associated with the first DU to the first DU. The first DU may output (e.g., to the UE 115-a) a control message indicating for the UE 115-a to transmit a RACH message to the candidate cell (e.g., to the second DU) using one of the one or more RACH resources associated with the first DU. The UE 115-a may transmit (e.g., to the second DU) the RACH message via the indicated RACH resource. By partitioning the RACH-resources of a candidate cell per serving DU, the second DU may associate the RACH message with the first DU based on the RACH resource being associated with the first DU. The second DU may identify the first DU ID associated with the first DU based on the RACH resource being associated with the first DU. The second DU may compute the TA value. The second DU may forward the TA value, an indication of the RACH resource corresponding to the first DU, or the first DU ID to the CU of the network entity 105-a, or any combination thereof. The CU may forward the TA value to the first DU based on the first DU ID or the indication of the RACH resource, or based on the resource via which TA value was forwarded or the resources via which the RACH message was transmitted (e.g., based on a resource ID). The first DU may associate the TA value with the UE 115-a based on the first DU outputting the control message to the UE 115-a. In some cases, the first DU may associate the TA value with the UE 115-a based on an indication of the RACH resource associated with the RACH message and TA value. For example, the first DU may assign the TA value to the UE 115-a that sent the RACH preamble (e.g., the RACH message). The first DU may provide the TA value with an indication to perform the low level mobility procedure (e.g., via a MAC CE). In some cases, RACH occasion information may be an example of random access radio network terminal identifier (RA-RNTI). Such procedures may rely on a single CU at the network entity 105-a coordinating across multiple DUs. However, such procedures may fail across network entities (e.g., across CUs, each serving multiple DUs, or across separate network entities 105) without a mechanism to coordinate between CUs or across network entities 105.

In some cases, it may be beneficial for the UE 115-a to perform an early RACH procedure and low level mobility procedure between different network entities 105. For example, a source network entity 105-a may serve the UE 115-a, and the UE 115-a may be configured with a candidate cell of a target network entity 105-b.

According to techniques described herein, a UE 115-a may perform an early RACH procedure and a low level mobility procedure for switching between a cell at a source network entity 105-a and a candidate cell at a target network entity 105-b (e.g., where one or more of the network entities 105 include one or more CUs, one or more DUs, or both). The low level mobility procedure may extend the early TA acquisition (including PDCCH-ordered RACH) such that the UE 115-a may switch between the source network entity 105-a and the target network entity 105-b. The low level mobility procedure may share RACH resources across network entities 105 (e.g., RACH resource may be shared across network entities 105 for LTM purpose). The early RACH procedure may reduce latency during a mobility procedure between two different network entities 105, as illustrated in FIG. 3.

In some cases, as described herein, the network entities 105 may perform the early RACH procedure, where the RACH resources are partitioned at the target network entity 105-b. For example, techniques described herein support early RACH procedures and handovers based thereon according to partitioned RACH resources that are shared across network entities 105 (e.g., where one or more of the network entities 105 correspond to one or more CUs, each of which may correspond to one or more DUs), the target network entity 105 may partition RACH resources of the candidate cell across all network entities 105 or DUs serving UEs 115 that are configured with the candidate cell as a candidate cell (e.g., an LTM candidate cell).

For example, according to techniques described herein, a first CU of the source network entity 105-a may output, to a second CU of the target network entity 105-b, a resource request 305 (e.g., via Xn) for RACH resources for each DU of the source network entity 105-a. The request for RACH resources (e.g., resource request 305) may include an indication of a candidate cell ID, a first DU ID associated with a first DU of the source network entity 105-a, and a second DU ID associated with a second DU of the source network entity 105-a. The second CU of the target network entity 105-b may forward (e.g., output) the request to a third DU of the target network entity 105-b. The second CU may include, in the output, an ID associated with the source network entity 105-a (e.g., a gNB ID, a public land mobile network (PLMN) ID, or a network ID (NID)) with the forwarded request. The third DU of the target network entity may return (e.g., output) an indication of one or more RACH resource partitions (e.g., a first set of RACH resources associated with the first DU of the source network entity 105-a and a second set of RACH resources associated with the second DU of the source network entity 105-a). The third DU of the target network entity 105-b may include, in the output, the candidate cell ID, the first DU ID associated with the first DU of the source network entity 105-a, the second DU ID associated with the second DU of the source network entity 105-a, or the ID associated with the source network entity 105-a with the indication of the one or more RACH resource partitions. The second CU of the target network entity 105-b may output the one or more RACH resource partitions (e.g., transmit an indication of resources 310) to the first CU of the source network entity 105-a (e.g., via Xn). The second CU of target network entity 105-b may include, in the output, the candidate cell ID, the first DU ID associated with the first DU of the source network entity, or the second DU ID associated with the second DU of the source network entity 105-a with the indication of resources 310. The first CU of the source network entity 105-a may forward an indication of the one or more RACH resource partitions to the respective DU associated with the RACH partition (e.g., the first CU of the source network entity 105-a may forward (e.g., output) the first set of RACH resources associated with the first DU of the source network entity 105-a to the first DU of the source network entity 105-a, and the second set of RACH resources associated with the second DU of the source network entity 105-a to the second DU of the source network entity 105-a). The first CU of the source network entity 105-a may include, in the output, the candidate cell ID or a UE ID associated with the UE 115-a with the indication of the one or more RACH resource partitions.

In some cases, the UE 115-a may be served by the first DU of the source network entity 105-a. The first DU of the source network entity 105-a may output a control message 315 indicating a RACH resource of the first set of RACH resources associated with the first DU of the source network entity 105-a (e.g., a PDCCH order to transmit a RACH message 320 to the candidate cell). The UE 115-a may transmit the RACH message 320 (e.g., RACH msg 1) to the candidate cell of the third DU of the target network entity 105-b via the indicated RACH resource. The third DU of the target network entity 105-b may calculate a TA value 325 associated with the UE 115-a based on obtaining the RACH message 320. The third DU of the target network entity 105-b may forward (e.g., output) the TA value 325 and an indication of the RACH resource associated with the RACH message 320 to the second CU of the target network entity 105-b. The third DU of the target network entity 105-b may include, in the output, the candidate cell ID, the first DU ID associated with the first DU (e.g., the DU associated with the RACH resource), or the ID associated with the source network entity 105-a with the TA value 325 and the indication of the RACH resources. The second CU of the target network entity 105-b may output the TA value 325 to the first CU of the source network entity 105-a based on the RACH resource indicated by the third DU of the target network entity 105-b being associated with the first DU of the source network entity 105-a. The second CU of the target network entity 105-b may include, in the output, the candidate cell ID, the first DU ID associated with the first DU of the source network entity, or an indication of the RACH resource with the TA value 325. The first CU of the source network entity 105-a may forward (e.g., output) the TA value 325 to the first DU of the source network entity 105-a. The first CU may include, in the output, an indication of the RACH resource with the TA value 325.

Techniques described herein may be applicable to various scenarios, including scenarios in which the network entities 105 both support split architectures. However, not all network entities 105 may support split architectures (e.g., a network entity 105 may support a unified architecture). Network entities 105 that support a unified architecture (e.g., do not support split architecture) may skip one or more internal CU to DU communications for an early RACH procedure described herein. Further, for network entities 105 that support split architecture, some or all aspects of the split architecture may not be exposed to external aspects of one or more network entities.

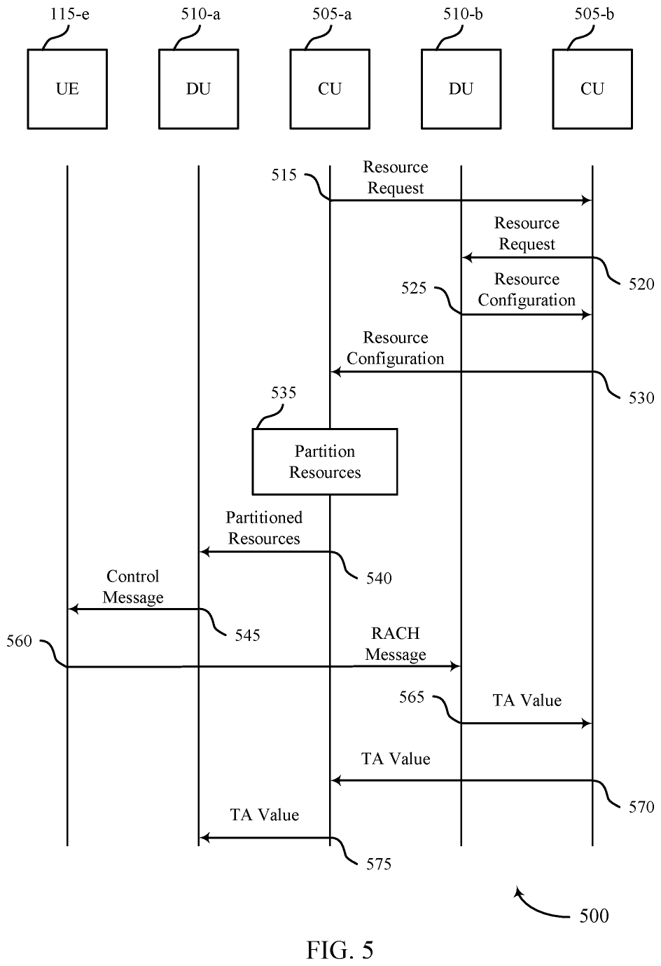

In some cases, the network entities 105 may perform an early RACH procedure and the low level mobility procedure, where RACH resources are partitioned hierarchically. For example, the CU of the target network entity 105-b may partition RACH resources between network entities 105 and the network entities 105 may partition RACH resources associated with the respective network entity 105 between DUs of the network entity 105. The hierarchical partitioning is described in more detail with reference to FIG. 5, and may support the low level mobility procedures even without access to split architecture status and structure of other network entities 105.

The hierarchical partitioning may be transparent to the internal architecture of the source network entity 105-a and the target network entity 105-b. For example, the source network entity 105-a or the target network entity 105-b may have a split architecture (e.g., the network entities 105 may include a CU and one or more DUs) as described with reference to FIG. 4. In some examples, the source network entity 105-a or the target network entity 105-b may have a unified architecture (e.g., not a have split architecture) as described with reference to FIG. 4. In hierarchical partitioning, the source network entity 105-a may request RACH resource from the target network entity 105-b without the target network entity 105-b knowing the internal structure of the source network entity 105-a (e.g., without knowing about the one or more DUs of the source network entity 105-a).

FIG. 4 shows an example of a wireless communications system 400 that supports early TA acquisition for mobility procedures in accordance with one or more aspects of the present disclosure. In some examples, wireless communications system 300 may implement aspects of wireless communications system 100, the network architecture 200, or the wireless communications system 300. A network entity 105-c, a network entity 105-d, and a network entity 105-e may be examples of corresponding devices described with reference to FIGS. 1-3. A UE 115-b, a UE 115-c and a UE 115-d may be examples of corresponding devices described with reference to FIGS. 1-3. In some cases, the network entity 105-c and the network entity 105-d may correspond to a CU 405 and one or more DUs 410, as described with reference to FIGS. 1-3.

In some cases, the network entity 105-c may be an example of the source network entity 105-a as described with reference to FIG. 3. The network entity 105-c have a split architecture. The network entity 105-c may include a first CU 405-a which may be an example of the first CU as described with reference to FIG. 3. The network entity 105-c may include a first DU 410-a and a second DU 410-b which may be examples of the first DU and the second DU as described with reference to FIG. 3. In some cases, the network entity 105-e may be an example of the source network entity 105-a as described with reference to FIG. 3. The network entity 105-e may have a unified architecture. In some cases, the network entity 105-d may be an example of the target network entity 105-b as described with reference to FIG. 3. The network entity 105-d may have a split architecture. The network entity 105-d may include a CU 405-b which may be an example of the second CU as described with reference to FIG. 3. The network entity 105-d may include the DU 410-c which may be an example of the third DU as described with reference to FIG. 3.

According to techniques described herein, the network entity 105-d (e.g., a target network entity 105) may support an early RACH procedure and low level mobility procedure including hierarchical partitioning, as described with reference to FIG. 5, with the network entity 105-c (e.g., a source network entity 105) or the network entity 105-e (e.g., a source network entity 105), or both for a candidate cell of the DU 410-c. The network entity 105-d may support techniques described with reference to FIG. 5 without access to any information regarding the internal structure of the network entity 105-c and the network entity 105-e. That is, the network entity 105-c and the network entity 105-d may perform the early RACH procedure and low level mobility procedures described herein without the network entity 105-d determining or otherwise detecting the split architecture supported by the network entity 105-c. Similarly, the network entity 105-e and the network entity 105-d may perform the early RACH procedure and low level mobility procedures described herein without the network entity 105-d determining or otherwise detecting the unified architecture supported by the network entity 105-e. For instance, the network entities 105 may perform an early RACH procedure and the low level mobility procedure, where RACH resources are partitioned hierarchically. For example, the CU 405-b of the target network entity 105-d may partition RACH resources between network entities 105 (e.g., the network entity 105-c, the network entity 105-e, or both) and the network entities 105 may partition RACH resources associated with the respective network entity 105 between DUs 410 of the network entities 105. The hierarchical partitioning is described in more detail with reference to FIG. 5.

FIG. 5 shows an example of a process flow 500 that supports early TA acquisition for mobility procedures in accordance with one or more aspects of the present disclosure. In some examples, process flow 500 may implement aspects of, or be implemented by aspects of, the wireless communication system 100, the network architecture 200, wireless communications system 300, or wireless communications system 400. For example, the process flow 500 may include a UE 115-e, a first DU 510-a, a second DU 510-b, a first CU 505-a, and a second CU 505-b which may be examples of corresponding devices described with reference to FIGS. 1-4. The first CU 505-a and the first DU 510-a may correspond to the source network entity 105, as described with reference to FIGS. 3 and 4 (e.g., the first CU 505-a may be an example of the first CU 405-a, and the first DU 510-a may be an example of the first DU 410-a). The second CU 505-b and the second DU 510-b may be of the target network entity 105, as described with reference to FIGS. 3 and 4 (e.g., the second CU 505-b may be an example of the CU 405-b, and the second DU 510-b may be an example of the DU 410-c).

The source network entity 105 may perform an early RACH procedure and low level mobility procedure including hierarchical partitioning with the target network entity 105 to switch the UE 115-e from a current cell of the source network entity 105 to a candidate cell of the target network entity 105. In some cases, the source network entity 105 may perform an early RACH procedure with the target network entity 105 prior to the hierarchical partitioning, as described with reference to FIG. 3. Techniques described with reference to FIG. 5 may be applicable for any source network entity and any target network entity (e.g., whether the source network entity supports split architecture or unified architecture), and may support early RACH procedures and low level mobility procedures without insight by one network entity into the architecture of other network entities.

At 515, the first CU 505-a of the source network entity 105 may output a resource request (e.g., via an Xn request) to the second CU 505-b of the target network entity 105. The resource request may include a request for one or more RACH resource sets (e.g., a partition of RACH resources for each DU 510 of the source network entity 105) and a candidate cell ID. The source network entity 105 may request the one or more RACH resource sets of the candidate cell without referring to the serving DUs 510 (e.g., the first DU 510-a or another DU 510 of the source network entity 105). In some examples, the resource request may include a quantity of sets of RACH resources (e.g., a quantity of sets may be equal to a quantity of DUs served by or corresponding to the first CU 505-a). In some cases, the source network entity 105 may request the one or more RACH resource sets of the candidate cell for the source network entity 105 or for one or more additional network entities 105 (e.g., the source network entity 105 may request one or more RACH resource sets for the source network entity 105 and on behalf of one or more other source network entities 105). In some cases, the resource request may include an ID associated with the source network entity 105-a (e.g., a gNB ID, a PLMN ID, or a NID) or a list of IDs (e.g., one or more gNB ID, one or more PLMN ID, or one or more NID) associated with one or more additional network entities 105.

The source network entity 105 may output, to the target network entity 105, an indication that the resource request is requesting resources on behalf of one or more additional network entities 105 (e.g., a third network entity 105). In some cases, the resource request including a request for resources on behalf of one or more additional network entities 105 may be transparent to the target network entity 105. For example, the target network entity 105 may forward an indication of resources to the source network entity 105 entity along with assistance info such as resource indication. The source network entity 105 may forward a TA value to the third network entity 105 based on the assistance info and prior assignment of the resource (e.g., partitioning at the source network entity 105).

At 520, the second CU 505-b may forward (e.g., output) the RACH resource request (e.g., as an F1 RACH resource request) and the candidate cell ID to the second DU 510-b based on the candidate cell being associated with the second DU 510-b. The second CU 505-b may include, in the output, an ID associated with the source network entity 105, a list of IDs associated with one or more additional network entities 105 or a quantity of the one or more RACH resource sets with the forwarded request. In some cases, the second CU 505-b may include, in the output, one or more DU IDs associated with the source network entity 105 (e.g., the second CU 505-b may generate a dummy or virtual ID, which may be referred to as a fake DU ID, for communicating with the second DU 510-b) or the one or more additional network entities 105 with the forwarded request.

At 525, the second DU 510-b of the target network entity 105 may output a RACH resource configuration. The RACH resource configuration may include, in the output, an indication of the one or more RACH resource sets, the candidate cell ID, and corresponding markings (e.g., the DU ID, dummy DU ID, gNB ID, quantity of RACH resource etc., PLMN ID, NID, list of IDs associated with the one or more additional network entities 105, or any combination thereof). In some aspects, the RACH resource configuration may be output via an F1 message.

At 530, the second CU 505-b may output (e.g., via an Xn message) an indication of the one or more RACH resource sets and the candidate cell ID to the first CU 505-a.

At 535, the first CU 505-a of the source network entity 105 may partition the one or more RACH resource sets between the one or more DUs 510 of the source network entity 105. For example, the first CU 505-a may associate each RACH resource set with a DU of the one or more DUs 510 of the source network entity 105. In other words, a CU of a serving network entity 105 (e.g., the first CU 505-a of the source network entity 105) may partition the RACH resources of the candidate cell among one or more DUs of the serving network entity 105. Partitioning RACH resources may include dividing the RACH resources into subsets (e.g., subsets of ROs, subsets of RACH preambles, among other examples).

In some cases, the source network entity 105 may partition one or more RACH resource sets to the one or more additional network entities 105 (e.g., based on requesting one or more RACH resource sets on behalf of the one or more additional network entities 105). For example, the first CU 505-a may partition the some of the one or more RACH resource sets between the one or more DUs 510 of the source network entity 105, and the first CU 505-a may partition some of the one or more RACH resource sets to the one or more additional network entities 105. The source network entity 105 may forward an indication of one or more RACH resource sets associated with an additional network entity 105 of the one or more additional network entities 105 to the additional network entity 105.

At 540, the first CU 505-a may output an indication the partitioned resources (e.g., an indication of each RACH resource set to each respective DU 510). For example, the first CU 505-a may output an indication of a first RACH resource set to the first DU 510-a of the source network entity 105. Additionally, or alternatively, the first CU 505-a may output an indication of a second RACH resource set to another DU 510 of the source network entity 105. In some aspects, a CU 505 may be associated with two DUs 510 (e.g., first DU 510-a illustrated in FIG. 5 may be two separate DUs 510), and the first CU 505-a may output the indication of the partitioned resources to each of the two DUs 510.

At 545, the first DU 510-a may output a control message (e.g., PDCCH order) to the UE 115-e. The control message may indicate for the UE 115-e to transmit a RACH message to the second DU 510-b via a RACH resource of the first RACH resource set associated with the candidate cell of the second DU 510-b. As discussed above, the first DU 510-a illustrated in FIG. 5 may be two separate DUs 510 and one of the DUs 510 may output the control message.

At 560, the UE 115-e may transmit a RACH message via the indicated RACH resource to the second DU 510-b. For example, the UE 115-e may transmit a RACH msg1.

At 565, the second DU 510-b may output a TA value to the second CU 505-b. The second DU 510-b may include, in the output, the candidate cell ID, the ID associated with the source network entity 105, an ID associated one of the additional network entities 105, the DU ID associated with the source network entity 105, a dummy or fake source DU ID, or an indication of the RACH resource associated with the RACH message.

At 570, the second CU 505-b may output the TA value to the first CU 505-a of the source network entity 105 or an additional network entity 105 of the one or more additional network entities 105 (e.g., the target network entity 105 may directly forward the TA value to the additional network entity 105 along with an indication of the RACH resource). The second CU 505-b may include, in the output, the candidate cell ID or an indication of the RACH resource associated with the RACH message with the TA value. In some cases, the second CU 505-b may output the TA value to the first CU 505-a based on the RACH resource being associated with (e.g., allocated to) the source network entity 105 (e.g., the RACH resource may be associated with the source network entity based on the RACH resource configuration obtained from the second DU 510-b).

The first CU 505-a may identify the first DU 510-a based on the RACH resource information (e.g., the indication of the RACH resource associated with the RACH message) and the prior partitioning (e.g., the partitioning performed by the first CU 505-a). For example, the first CU 505-a may determine that the TA value corresponding to the indicated RACH resource is associated with the first DU 510-a.

In some cases, the first CU 505-a may determine whether the TA result is to be forwarded to another network entity, or to a DU 510-a, based on the RACH resource information and the prior partitioning performed at 535. In some examples, the first CU 505-a may identify an additional network entity 105 of the one or more additional network entities 105 based on the RACH resource information (e.g., the indication of the RACH resource associated with the RACH message) and the prior partitioning (e.g., the partitioning performed by the first CU 505-a). For example, the first CU 505 may determine that the TA value corresponding to the indicated RACH resource is associated with the additional network entity 105.

At 575, the first CU 505-a may forward (e.g., output) the TA value associated with the candidate cell to the first DU 510-a. The first CU 505-a may include, in the output, an indication of the RACH resource with the TA value. In some cases, the first CU 505-a may forward (e.g., relay) the TA value to an additional network entity 105 based on identifying the additional network entity 105 (e.g., according to the resource information indicated in the resource configuration information indicated at 530 and the partitioning performed at 535).

In some cases, the second CU 505-b may receive two resource requests from multiple source network entities 105 (e.g., at 515). The second CU 505-b may query the second DU 510-b for RACH resources per serving network entity 105. The second CU 505-b may return the resources allocated by the second DU 510-b to the respective source network entity 105. In some cases, each resource request may include a quantity of sets of RACH resources (e.g., a quantity of RACH resources required for each source network entity 105).

In some cases, the second CU 505-b may receive more than two request for multiple source network entity 105. The source network entity 105 may configure the UE 115 with candidate cell on the source network entity 105, the target network entity 105, or another target network entity 105. In some cases, a first network entity 105 may request RACH resources for RACH configuration from a second network entity 105. For example, a first network entity 105 may request RACH resource from a target network entity 105 for the first network entity 105 and the second network entity 105. The first network entity 105 may forward the RACH resources for the second network entity 105 to the second network entity 105. In other words, the first network entity 105 may share a RACH configuration with other candidate network entities 105. The first network entity 105 may request RACH preamble ID or masks from the target network entity 105 on behalf of another network entity 105 (e.g., the second network entity 105). In some cases, the signaling between the CUs 505, the DUs 510, and the UEs 115 may use UE-associated Xn messages or non-UE associated (NUA) Xn message. In some examples, the second network entity may ask another network entity 105 for RACH resources when configuring a UE 115 with LTM or when receiving a request from another network entity 105 to configure one of its served cells as an LTM candidate.

In some examples, the uplink synchronization (e.g., the early RACH procedure) may be performed according to the TA value. The TA value may be forwarded to a second or additional network entity (e.g., either directly from the target network entity, such as from the CU 505-b, or via the source network entity, such as the CU 505-a). In some examples (e.g., at 515), the source network entity (e.g., the CU 505-a) may explicitly indicate to the target entity (e.g., the CU 505-b) that the resources requested are on behalf of another network entity. In some examples, the source network entity (e.g., the CU 505-a) may not indicate to the target entity (e.g., the CU 505-b) that the resources requested are on behalf of another network entity. In such examples, the target entity (e.g., the CU 505-b) may forward the TA value to the CU 505-a along with assistance information (e.g., such as the resource indication, indicating via which resources the RACH message was received at 560). The source entity (e.g., the CU 505-a may determine, based on the assistance information, the prior assignment of resources (e.g., to the third network entity) that the TA results should be forwarded to the third network entity.

In some cases, communication between the target network entity 105 and the source network entity 105 may use Xn or next-generation (NG) (e.g., via AMF).

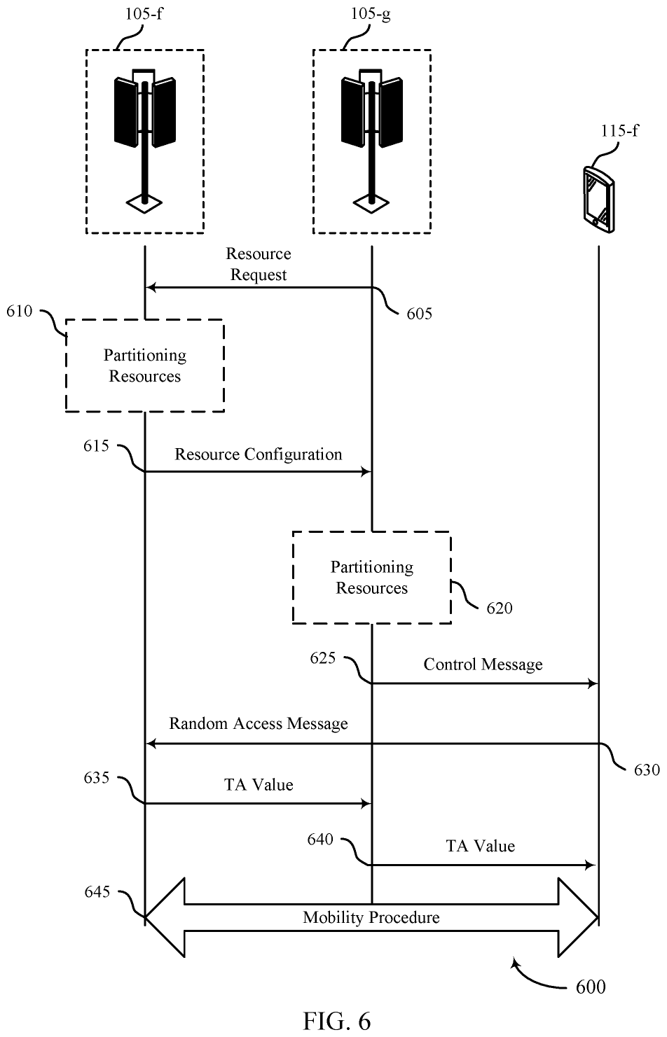

FIG. 6 shows an example of a process flow 600 that supports early TA acquisition for mobility procedures in accordance with one or more aspects of the present disclosure. In some examples, process flow 600 may implement aspects of, or be implemented by aspects of, the wireless communication system 100, the network architecture 200, wireless communications system 300, wireless communications system 400, or process flow 500. For example, the process flow 600 may include a UE 115-f, a source network entity 105-g, and a target network entity 105-f which may be examples of corresponding devices described with reference to FIGS. 1-4. In some cases, the target network entity 105-f and the source network entity 105-g may include a CU and one or more DUs, as described with reference to FIGS. 1-5.

At 605, the target network entity 105-f may obtain a request for one or more random access (e.g., RACH) resources associated with a candidate cell served by a target network entity 105-f. In some cases, the target network entity 105-f may obtain, at a CU of the target network entity, the request for the one or more random access resources.

In some cases, the request for one or more random access resources may include an identifier associated with the UE 115-e (a UE identifier), a candidate cell identifier, a request for an LTM configuration or handover preparation (e.g., based on the mobility procedure), a list of one or more network entity identifier or DU identifier associated with one or more network entities 105 or DUs 510 associated with the source network entity 105, a list of one or more cell identifiers associated with cells served by the source network entity 105, or a quantity of requested random access resource configurations.

In some cases, the request may include an indication that the one or more random access resources correspond to an uplink synchronization procedure (e.g., an indication that the RACH resource is used for the purpose of performing an uplink synchronization procedure, such as an early RACH procedure described with reference to FIG. 3-5) between a UE 115-f served by the source network entity 105-g and the candidate cell served by the target network entity 105-f, the synchronization procedure to occur prior to triggering a mobility procedure (e.g., the low level mobility procedure described with reference to FIGS. 3-5) of the UE 115-f from the source network entity 105-g to the target network entity 105-f. The mobility procedure may be an example of an LTM or L3 mobility procedure.

In some cases, the target network entity 105-f may output, by the CU of the target network entity 105-f, a second request for one or more random access resources associated with one or more DUs of the target network entity 105-f to the one or more DUs of the target network entity 105-f based on the request for one or more random access resources. The second request may include an identifier associated with the source network entity 105-g, an identifier associated with a DU associated with the source network entity 105-g, an identifier associated with a cell served by the source network entity 105-g, a virtual identifier corresponding to a virtual DU associated with the source network entity 105-g, or a combination thereof. The virtual identifier may include an indication of an identifier of the source network entity 105-g or a network entity 105 or a DU associated with the source network entity 105-g or a cell served by the source network entity 105-g, allocated by the CU of the target network entity 105-f (e.g., a fake DU identifier as described with reference to FIG. 5). Additionally, or alternatively, one or more information in the second request may be based on information in the random access request (e.g., the second request may include information from the first request).

In some cases, the target network entity 105-f may obtain, from the one or more DUs by the CU of the target network entity, an indication of the random access resource configuration based on outputting the second request to the one or more DUs of the target network entity 105-f. Outputting the random access resource configuration may include outputting, by the CU of the target network entity 105-f, the random access resource configuration indicating the one or more random access resources associated with the one or more DUs based on obtaining the random access resource configuration from the one or more DUs.

In some cases, the indication of the random access resource configuration obtained from the one or more DUs may include, an identifier associated with the source network entity 105-g, a DU identifier associated with the source network entity 105-g, an identifier associated with a cell served by the source network entity 105-g, a virtual identifier corresponding to a virtual DU associated with the source network entity 105-g, or a combination thereof.

In some cases, at 610, the target network entity 105-f may partition the one or more random access resources into a first set of random access resources and a second set of random access resources as described in greater detail with reference to FIG. 2. A random access resource configuration may include an indication of the partitioning at the target network entity 105-f. The first set of random access resources may include a first set of one or more random access preambles, and the second set of random access resources may include a second set of one or more random access preambles.

In some cases, at 610, the target network entity 105-f may partition the one or more random access resources into a first set of random access resources and a second set of random access resources as described in greater detail with reference to FIG. 2. The random access resource configuration may include an indication of the partitioning at the target network entity 105-f. The first set of random access resources may include a first set of one or more random access occasions, and the second set of random access resources may include a second set of one or more random access occasions.

At 615, the target network entity 105-f may output the random access resource configuration indicating the one or more random access resources and the candidate cell based on the request. The one or more random access resources may be associated with a partition at a source network entity. In some cases, the random access resource configuration includes a UE identifier, a candidate cell identifier associated with the candidate cell, LTM candidate configuration information, a mobility command, or a combination thereof.

In some cases, the message including the random access resource configuration may further include an indication of an association between the set of random access resources and a respective cell identifier of the list of cell identifiers or respective DU identifier of the list of DU identifiers.

In some cases, a message including the random access resource configuration may include a list of one or more cell identifiers, a set of random access resources may include the one or more random access resources, a user identifier (e.g., a UE identifier), a cell identifier associated with the target network entity 105-f, an LTM candidate configuration, a handover command, a list of DU identifiers corresponding to DUs corresponding to the source network entity 105-g, a list of cell identifiers corresponding to cells served by the source network entity 105-g, or any combination thereof. In some cases, the LTM candidate configuration or the handover command may be based on or for conditional mobility. The one or more random access resources may include one or more one or more random access preamble identifiers, one or more random access occasions, or RA-RNTIs, among other examples. The list of DU identifiers may include one or more network entity identifiers or DU identifiers associated with the target network entity 105-f. The list of DU identifiers may include an association between the one or more random access resources or sets of RACH resources and the one or more network entity identifiers or DU identifiers. The list of cell identifiers may include an association between the one or more random access resources or sets of random access resources and the one or more cell identifiers. In some cases, the transmission of the resource configuration may be based on the information in the resource configuration. The random access resource configuration may include one or more random access resource configurations. In some cases, the source network entity 105-g may forward a second random access resource configuration to a DU of the source network entity 105-g or another network entity 105.

In some cases, the target network entity 105-f may include a CU and a DU. The CU of the target network entity 105-f may transmit the random access resource configuration based on receiving the random access resource configuration from the DU.

In some cases, obtaining the random access resource configuration may include obtaining, at a CU of the source network entity 105-g, the random access resource configuration indicating the one or more random access resources associated with one or more DUs of the source network entity 105-g. In some cases, the source network entity 105-g may output, by the CU of the source network entity 105-g to a DU of one or more DUs of the source network entity 105-g, a second random access resource configuration indicating a set of one or more random access resources associated with the DU. In some cases, the random access resource configuration and the second random access resource configuration may include a same indication of the one or more random access resources.

Wherein the RACH resource configuration comprises a plurality of RACH resource configurations, wherein the second RACH resource configuration is a subset of the plurality of the configurations. Wherein the CU additionally includes at least one of a UE identifier or the candidate cell identifier

In some cases, at 620, the source network entity 105-g may partition the one or more random access resources indicated in the random access resource configuration as described in greater detail with reference to FIG. 5. The source network entity 105-g may partition the one or more random access resources between one or more DUs of the source network entity 105-g.

At 625, the source network entity 105-g may output a control message to a UE indicating a random access resource of the one or more random access resources associated with the random access resource configuration.

At 630, the target network entity 105-f may obtain a random access message via one of the one or more random access resources indicated by the random access resource configuration. In some cases, the target network entity 105-f may determine a TA value based on the random access message.

In some cases, the target network entity 105-f may obtain, at one or more DUs of the target network entity 105-f, the random access message via one of the one or more random access resources indicated by the random access resource configuration.

At 635, the target network entity 105-f may output, to the source network entity 105-g, the TA value associated with the UE 115-f based on the random access message. The mobility procedure may be based on the TA value. At 640, the source network entity 105-g may output the TA value to the UE 115-f. In some examples, the source network entity 105-g may output the TA value (e.g., to the UE 115-f) prior to a mobility procedure or during the mobility procedure (e.g., upon triggering the mobility procedure).

In some cases, the target network entity 105-f may output, by the one or more DUs to a CU of the target network entity, an indication of a TA value corresponding to the random access message, the indication of the TA value may include an identifier associated with the source network entity 105-g, a DU identifier associated with the source network entity 105-g, an identifier associated with a cell served by the source network entity 105-g, a network entity identifier indicated in the request for the one or more random access resources, or a combination thereof. The TA value may include a user identifier (e.g., a UE identifier), an indication of the random access resources (e.g., RACH occasion) on which the random access preamble may be received (e.g., RA-RNTI associated with the RACH occasion), or a random access preamble identifier of the received random access preamble.

In some cases, the source network entity 105-g may obtain, at a CU of the source network entity 105-g from a CU of the target network entity 105-f, an indication of a TA value corresponding to a random access message transmitted by the UE 115-f and an indication of a random access resource associated with the random access message. The UE 115-f may be served by a DU of the source network entity 105-g. The source network entity 105-g may output, by the CU of the source network entity 105-g to the DU of the source network entity 105-g, the TA value based on the random access resource being associated with the DU of the source network entity 105-g. A mobility procedure may be based on the TA value. For example, the CU of the source network entity 105-g may receive the TA value and an indication of a second random access resource configuration from the target network entity 105-f. The CU of the source network entity 105-g may forward the TA value to the DU of the source network entity 105-g to which the CU of the source network entity 105-g previously forwarded the second random access resource configuration.

In some cases, the indication of the second random access resource configuration include a preamble identifier or an indication of a random access occasion included in the second random access resource configuration. In some cases, the indication of the second random access resource configuration may include an identifier associated with the DU of the source network entity 105-g. The indication of the second random access resource configuration may include a UE identifier or a candidate cell identifier.

At 645, the source network entity 105-g may perform a mobility procedure of the UE 115-f from the source network entity 105-g to the target network entity 105-f in response to obtaining the random access message. In some cases, the source network entity 105-g may output a LTM cell switch command, a MAC CE, or a RACH response message including the TA value.

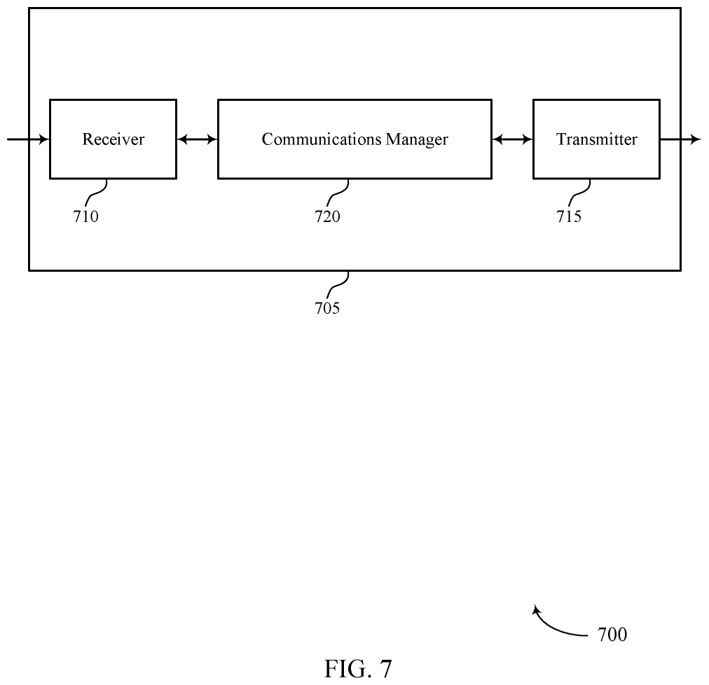

FIG. 7 shows a block diagram 700 of a device 705 that supports early TA acquisition for mobility procedures in accordance with one or more aspects of the present disclosure. The device 705 may be an example of aspects of a target network entity as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations or components thereof may be examples of means for performing various aspects of early TA acquisition for mobility procedures as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for obtaining a request for one or more random access resources associated with a candidate cell served by the target network entity. The communications manager 720 is capable of, configured to, or operable to support a means for outputting a random access resource configuration indicating the one or more random access resources and the candidate cell based on the request, where the one or more random access resources are associated with a partition at a source network entity. The communications manager 720 is capable of, configured to, or operable to support a means for obtaining a random access message via one of the one or more random access resources indicated by the random access resource configuration.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources and the like

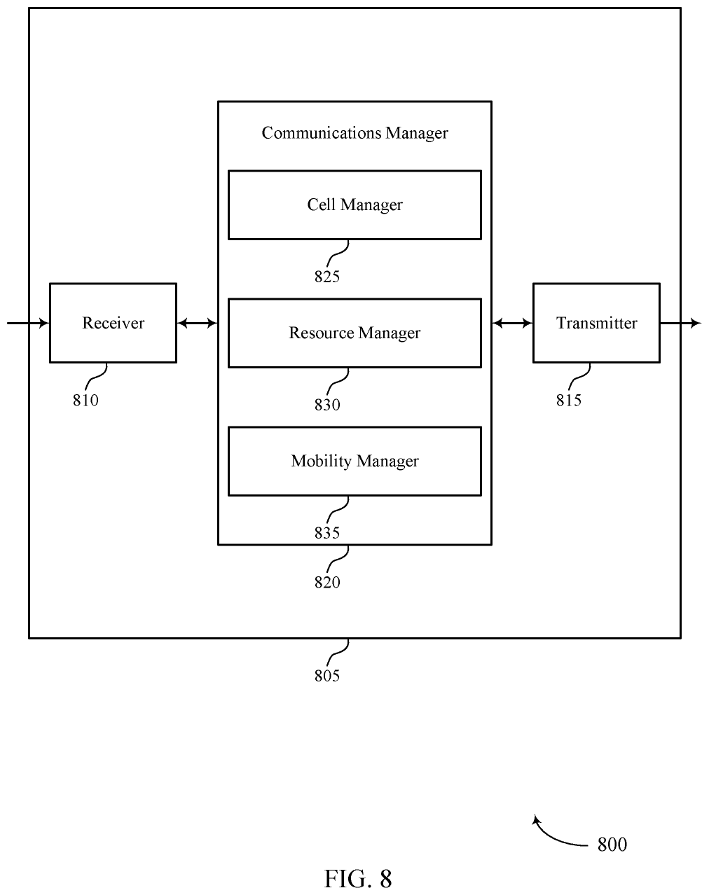

FIG. 8 shows a block diagram 800 of a device 805 that supports early TA acquisition for mobility procedures in accordance with one or more aspects of the present disclosure. The device 805 may be an example of aspects of a device 705 or a target network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of early TA acquisition for mobility procedures as described herein. For example, the communications manager 820 may include a cell manager 825, a resource manager 830, a mobility manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The cell manager 825 is capable of, configured to, or operable to support a means for obtaining a request for one or more random access resources associated with a candidate cell served by the target network entity. The resource manager 830 is capable of, configured to, or operable to support a means for outputting a random access resource configuration indicating the one or more random access resources and the candidate cell based on the request, where the one or more random access resources are associated with a partition at a source network entity. The mobility manager 835 is capable of, configured to, or operable to support a means for obtaining a random access message via one of the one or more random access resources indicated by the random access resource configuration.

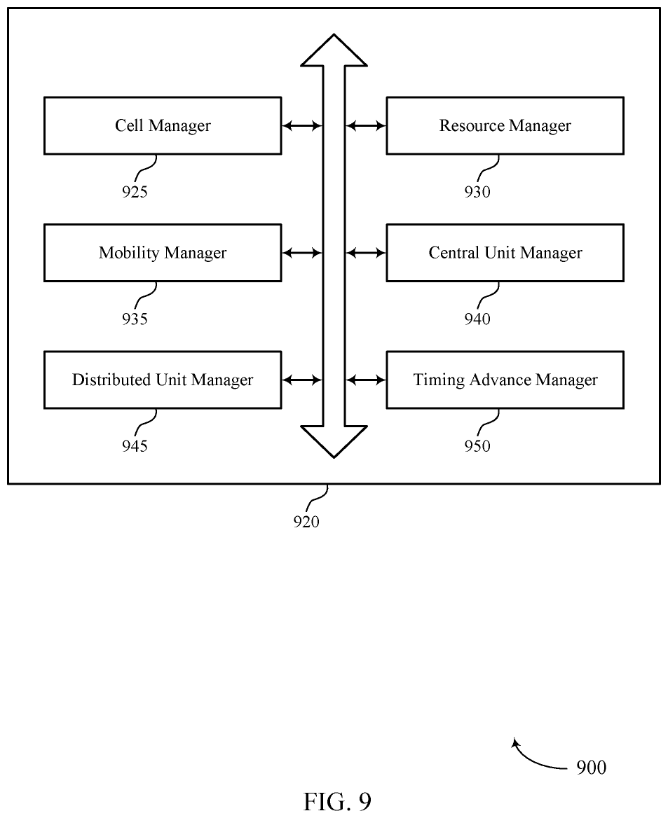

FIG. 9 shows a block diagram 900 of a communications manager 920 that supports early TA acquisition for mobility procedures in accordance with one or more aspects of the present disclosure. The communications manager 920 may be an example of aspects of a communications manager 720, a communications manager 820, or both, as described herein. The communications manager 920, or various components thereof, may be an example of means for performing various aspects of early TA acquisition for mobility procedures as described herein. For example, the communications manager 920 may include a cell manager 925, a resource manager 930, a mobility manager 935, a CU manager 940, a DU manager 945, a TA manager 950, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The cell manager 925 is capable of, configured to, or operable to support a means for obtaining a request for one or more random access resources associated with a candidate cell served by the target network entity. The resource manager 930 is capable of, configured to, or operable to support a means for outputting a random access resource configuration indicating the one or more random access resources and the candidate cell based on the request, where the one or more random access resources are associated with a partition at a source network entity. The mobility manager 935 is capable of, configured to, or operable to support a means for obtaining a random access message via one of the one or more random access resources indicated by the random access resource configuration.

In some examples, the mobility manager 935 is capable of, configured to, or operable to support a means for performing a mobility procedure of a UE from the source network entity to the target network entity in response to obtaining the random access message.

In some examples, the TA manager 950 is capable of, configured to, or operable to support a means for outputting, to the source network entity, a TA value associated with the UE based on the random access message, where the mobility procedure is based on the TA value.

In some examples, the random access resource configuration includes a UE identifier, a candidate cell identifier associated with the candidate cell, lower layer trigger mobility candidate configuration information, a mobility command, or a combination thereof.

In some examples, to support obtaining the request for one or more random access resources, the CU manager 940 is capable of, configured to, or operable to support a means for obtaining, at a CU of the target network entity, the request for the one or more random access resources.

In some examples, the CU manager 940 is capable of, configured to, or operable to support a means for outputting, by the CU of the target network entity, a second request for one or more random access resources associated with one or more DUs of the target network entity to the one or more DUs of the target network entity based on the request for one or more random access resources, where the second request includes an identifier associated with the source network entity, an identifier associated with a DU associated with the source network entity an identifier associated with a cell served by the source network entity, a virtual identifier corresponding to a virtual DU associated with the source network entity, or a combination thereof.

In some examples, the CU manager 940 is capable of, configured to, or operable to support a means for obtaining, from the one or more DUs by the CU of the target network entity, an indication of the random access resource configuration based on outputting the second request to the one or more DUs of the target network entity, where outputting the random access resource configuration includes outputting, by the CU of the target network entity, the random access resource configuration indicating the one or more random access resources associated with the one or more DUs based on obtaining the random access resource configuration from the one or more DUs.

In some examples, the indication of the random access resource configuration obtained from the one or more DUs includes, an identifier associated with the source network entity, a DU identifier associated with the source network entity, an identifier associated with a cell served by the source network entity, a virtual identifier corresponding to a virtual DU associated with the source network entity, or a combination thereof.

In some examples, to support obtaining the random access message, the DU manager 945 is capable of, configured to, or operable to support a means for obtaining, at one or more DUs of the target network entity, the random access message via one of the one or more random access resources indicated by the random access resource configuration.

In some examples, the DU manager 945 is capable of, configured to, or operable to support a means for outputting, by the one or more DUs to a CU of the target network entity, an indication of a TA value corresponding to the random access message, the indication of the TA value including an ID associated with the source network entity, a DU identifier associated with the source network entity, an identifier associated with a cell served by the source network entity, a network entity identifier indicated in the request for the one or more random access resources, or a combination thereof.

In some examples, to support a message including the random access resource configuration, the resource manager 930 is capable of, configured to, or operable to support a means for a list of one or more cell identifiers, a set of random access resources including the one or more random access resources, a user identifier, a cell identifier associated with the target network entity, an LTM candidate configuration, a handover command, a list of DU identifiers corresponding to DUs corresponding to the source network entity, a list of cell identifiers corresponding to cells served by the source network entity, or any combination thereof.

In some examples, the message including the random access resource configuration further includes an indication of an association between the set of random access resources and a respective cell identifier of the list of cell identifiers or respective DU identifier of the list of DU identifiers.

In some examples, the resource manager 930 is capable of, configured to, or operable to support a means for partitioning the one or more random access resources into a first set of random access resources and a second set of random access resources, where the random access resource configuration includes an indication of the partitioning at the target network entity, and where the first set of random access resources includes a first set of one or more random access preambles, and the second set of random access resources includes a second set of one or more random access preambles.

In some examples, the resource manager 930 is capable of, configured to, or operable to support a means for partitioning the one or more random access resources into a first set of random access resources and a second set of random access resources, where the random access resource configuration includes an indication of the partitioning at the target network entity, and where the first set of random access resources includes a first set of one or more random access occasions, and the second set of random access resources includes a second set of one or more random access occasions.

In some examples, the request includes an indication that the one or more random access resources correspond to an uplink synchronization procedure between a UE served by the source network entity and the candidate cell served by the target network entity, the synchronization procedure to occur prior to triggering a mobility procedure of the UE from the source network entity to the target network entity.

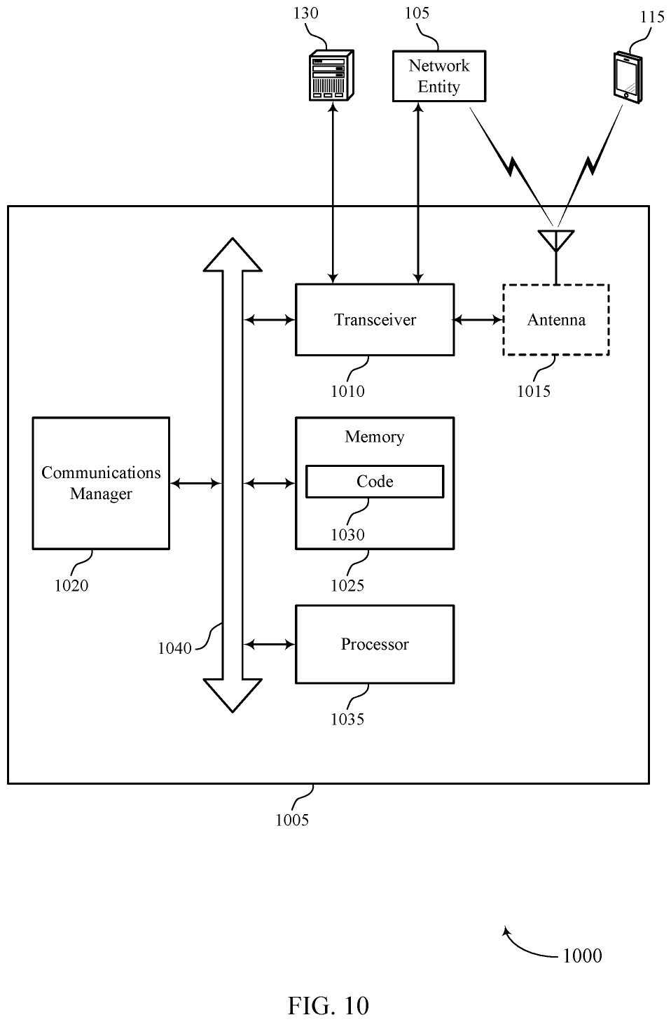

FIG. 10 shows a diagram of a system 1000 including a device 1005 that supports early TA acquisition for mobility procedures in accordance with one or more aspects of the present disclosure. The device 1005 may be an example of or include components of a device 705, a device 805, or a target network entity as described herein. The device 1005 may include components for bi-directional voice and data communications including components for transmitting and receiving communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting early TA acquisition for mobility procedures). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025). In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network devices 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communication in accordance with examples as disclosed herein. For example, the communications manager 1020 is capable of, configured to, or operable to support a means for obtaining a request for one or more random access resources associated with a candidate cell served by the target network entity. The communications manager 1020 is capable of, configured to, or operable to support a means for outputting a random access resource configuration indicating the one or more random access resources and the candidate cell based on the request, where the one or more random access resources are associated with a partition at a source network entity. The communications manager 1020 is capable of, configured to, or operable to support a means for obtaining a random access message via one of the one or more random access resources indicated by the random access resource configuration.

By including or configuring the communications manager 1020 in accordance with examples as described herein, the device 1005 may support techniques for reduced latency, improved user experience related to reduced processing, more efficient utilization of communication resources, improved coordination between devices, and the like.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of early TA acquisition for mobility procedures as described herein, or the at least one processor 1035 and the at least one memory 1025 may be otherwise configured to, individually or collectively, perform or support such operations.

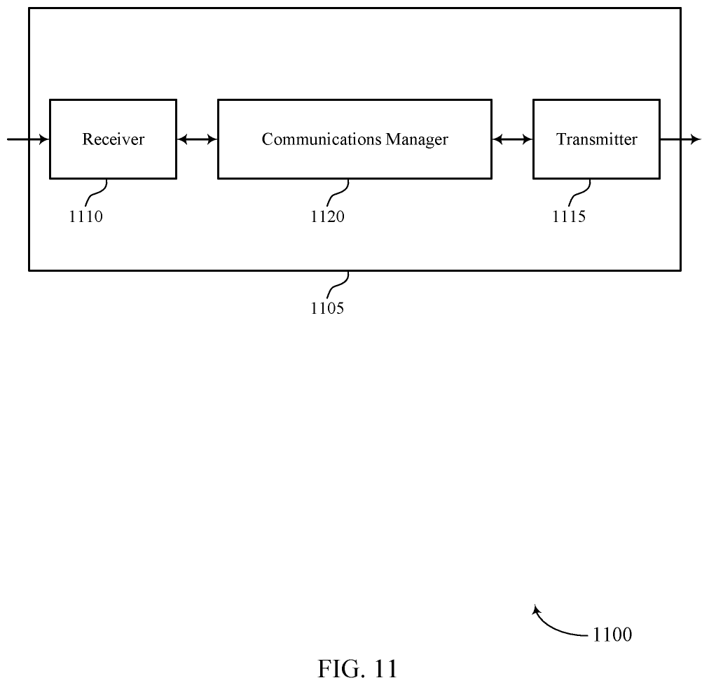

FIG. 11 shows a block diagram 1100 of a device 1105 that supports early TA acquisition for mobility procedures in accordance with one or more aspects of the present disclosure. The device 1105 may be an example of aspects of a source network entity as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of early TA acquisition for mobility procedures as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for outputting a request for one or more random access resources associated with a candidate cell served by a target network entity. The communications manager 1120 is capable of, configured to, or operable to support a means for obtaining a random access resource configuration indicating the one or more random access resources and the candidate cell based on the request, where the one or more random access resources are associated with a partition at the source network entity. The communications manager 1120 is capable of, configured to, or operable to support a means for outputting a control message to a UE indicating a random access resource of the one or more random access resources associated with the random access resource configuration.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources and the like.

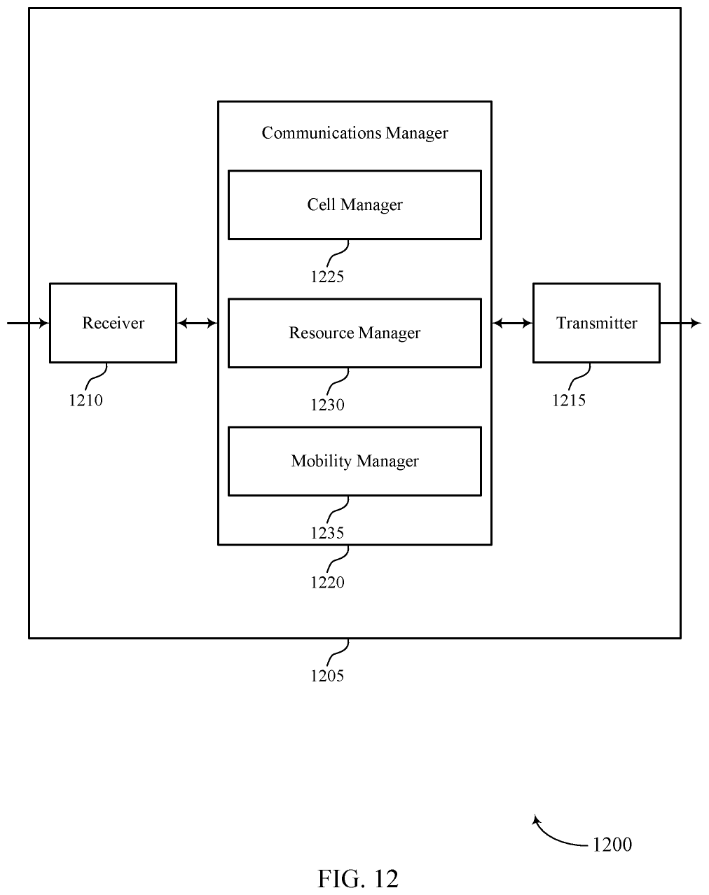

FIG. 12 shows a block diagram 1200 of a device 1205 that supports early TA acquisition for mobility procedures in accordance with one or more aspects of the present disclosure. The device 1205 may be an example of aspects of a device 1105 or a source network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of early TA acquisition for mobility procedures as described herein. For example, the communications manager 1220 may include a cell manager 1225, a resource manager 1230, a mobility manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The cell manager 1225 is capable of, configured to, or operable to support a means for outputting a request for one or more random access resources associated with a candidate cell served by a target network entity. The resource manager 1230 is capable of, configured to, or operable to support a means for obtaining a random access resource configuration indicating the one or more random access resources and the candidate cell based on the request, where the one or more random access resources are associated with a partition at the source network entity. The mobility manager 1235 is capable of, configured to, or operable to support a means for outputting a control message to a UE indicating a random access resource of the one or more random access resources associated with the random access resource configuration.

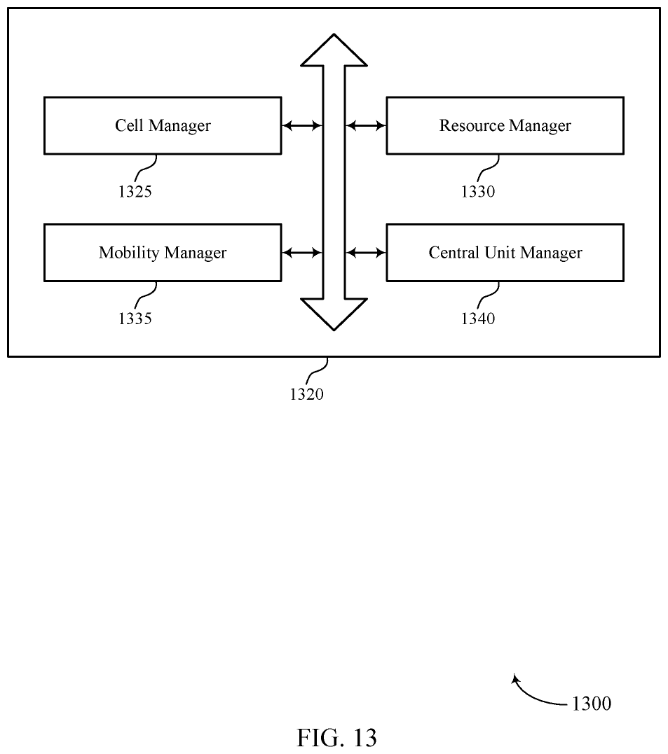

FIG. 13 shows a block diagram 1300 of a communications manager 1320 that supports early TA acquisition for mobility procedures in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of early TA acquisition for mobility procedures as described herein. For example, the communications manager 1320 may include a cell manager 1325, a resource manager 1330, a mobility manager 1335, a CU manager 1340, or any combination thereof. Each of these components, or components or subcomponents thereof (e.g., one or more processors, one or more memories), may communicate, directly or indirectly, with one another (e.g., via one or more buses).

The communications manager 1320 may support wireless communication in accordance with examples as disclosed herein. The cell manager 1325 is capable of, configured to, or operable to support a means for outputting a request for one or more random access resources associated with a candidate cell served by a target network entity. The resource manager 1330 is capable of, configured to, or operable to support a means for obtaining a random access resource configuration indicating the one or more random access resources and the candidate cell based on the request, where the one or more random access resources are associated with a partition at the source network entity. The mobility manager 1335 is capable of, configured to, or operable to support a means for outputting a control message to a UE indicating a random access resource of the one or more random access resources associated with the random access resource configuration.

In some examples, to support obtaining the random access resource configuration, the CU manager 1340 is capable of, configured to, or operable to support a means for obtaining, at a CU of the source network entity, the random access resource configuration indicating the one or more random access resources associated with one or more DUs of the source network entity.

In some examples, the CU manager 1340 is capable of, configured to, or operable to support a means for outputting, by the CU of the source network entity to a DU of one or more DUs of the source network entity, a second random access resource configuration indicating a set of one or more random access resources associated with the DU.

In some examples, the random access resource configuration and the second random access resource configuration include a same indication of the one or more random access resources.

In some examples, the CU manager 1340 is capable of, configured to, or operable to support a means for obtaining, at a CU of the source network entity from a CU of the target network entity, an indication of a TA value corresponding to a random access message transmitted by the UE and an indication of a random access resource associated with the random access message, where the UE is served by a DU of the source network entity. In some examples, the CU manager 1340 is capable of, configured to, or operable to support a means for outputting, by the CU of the source network entity to the DU of the source network entity, the TA value based on the random access resource being associated with the DU of the source network entity, where a mobility procedure is based on the TA value.

In some examples, the request includes an indication that the one or more random access resources correspond to an uplink synchronization procedure between the UE served by the source network entity and the candidate cell served by the target network entity, the synchronization procedure to occur prior to triggering a mobility procedure of the UE from the source network entity to the target network entity.

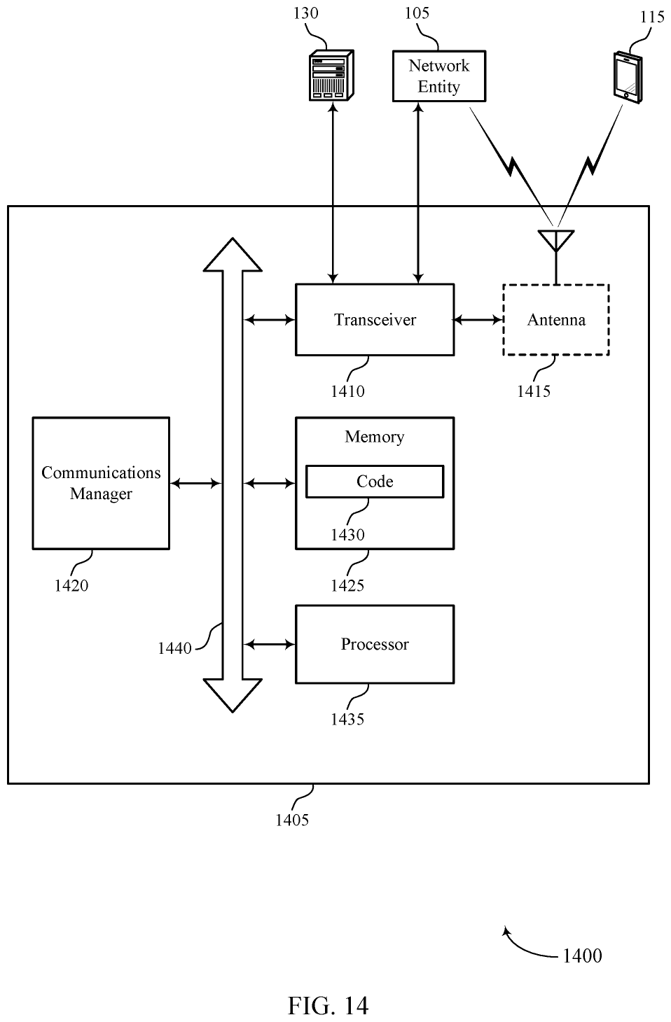

FIG. 14 shows a diagram of a system 1400 including a device 1405 that supports early TA acquisition for mobility procedures in accordance with one or more aspects of the present disclosure. The device 1405 may be an example of or include components of a device 1105, a device 1205, or a source network entity as described herein. The device 1405 may include components for bi-directional voice and data communications including components for transmitting and receiving communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting early TA acquisition for mobility procedures). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for outputting a request for one or more random access resources associated with a candidate cell served by a target network entity. The communications manager 1420 is capable of, configured to, or operable to support a means for obtaining a random access resource configuration indicating the one or more random access resources and the candidate cell based on the request, where the one or more random access resources are associated with a partition at the source network entity. The communications manager 1420 is capable of, configured to, or operable to support a means for outputting a control message to a UE indicating a random access resource of the one or more random access resources associated with the random access resource configuration.

By including or configuring the communications manager 1420 in accordance with examples as described herein, the device 1405 may support techniques for reduced latency, improved user experience related to reduced processing, more efficient utilization of communication resources, improved coordination between devices, and the like.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of early TA acquisition for mobility procedures as described herein, or the at least one processor 1435 and the at least one memory 1425 may be otherwise configured to, individually or collectively, perform or support such operations.

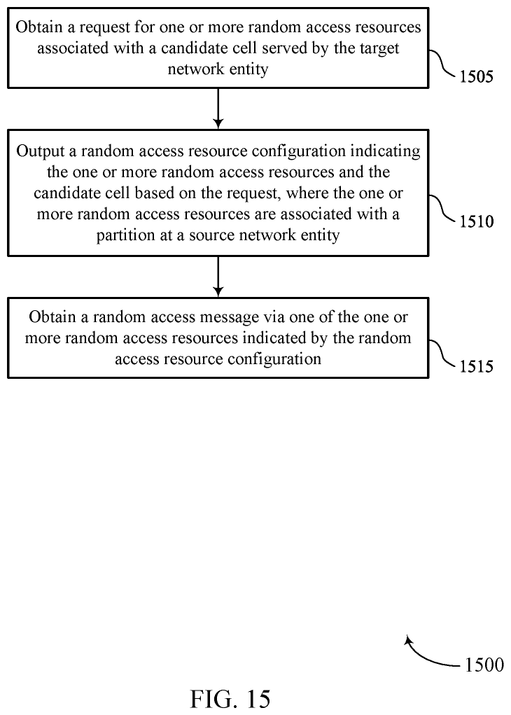

FIG. 15 shows a flowchart illustrating a method 1500 that supports early TA acquisition for mobility procedures in accordance with one or more aspects of the present disclosure. The operations of the method 1500 may be implemented by a target network entity or its components as described herein (e.g., a target network entity 105 as described with reference to FIG. 3-6). For example, the operations of the method 1500 may be performed by a target network entity as described with reference to FIGS. 1 through 10. In some examples, a target network entity may execute a set of instructions to control the functional elements of the target network entity to perform the described functions. Additionally, or alternatively, the target network entity may perform aspects of the described functions using special-purpose hardware.

At 1505, the method may include obtaining a request for one or more random access resources associated with a candidate cell served by the target network entity. The operations of 1505 may be performed in accordance with examples as disclosed herein, such as at 605 of FIG. 6. In some examples, aspects of the operations of 1505 may be performed by a cell manager 925 as described with reference to FIG. 9.

At 1510, the method may include outputting a random access resource configuration indicating the one or more random access resources and the candidate cell based on the request, where the one or more random access resources are associated with a partition at a source network entity. The operations of 1510 may be performed in accordance with examples as disclosed herein, such as at 615 of FIG. 6. In some examples, aspects of the operations of 1510 may be performed by a resource manager 930 as described with reference to FIG. 9.

At 1515, the method may include obtaining a random access message via one of the one or more random access resources indicated by the random access resource configuration. The operations of 1515 may be performed in accordance with examples as disclosed herein, such as at 630 of FIG. 6. In some examples, aspects of the operations of 1515 may be performed by a mobility manager 935 as described with reference to FIG. 9.

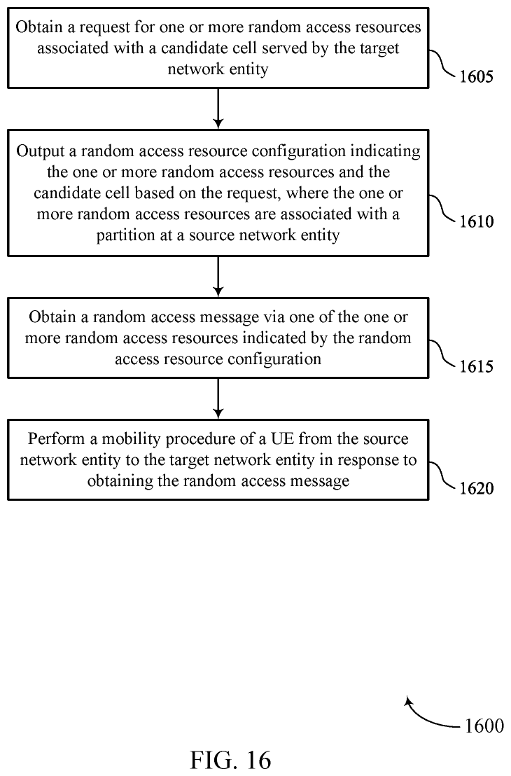

FIG. 16 shows a flowchart illustrating a method 1600 that supports early TA acquisition for mobility procedures in accordance with one or more aspects of the present disclosure. The operations of the method 1600 may be implemented by a target network entity or its components as described herein (e.g., a target network entity 105 as described with reference to FIG. 3-6). For example, the operations of the method 1600 may be performed by a target network entity as described with reference to FIGS. 1 through 10. In some examples, a target network entity may execute a set of instructions to control the functional elements of the target network entity to perform the described functions. Additionally, or alternatively, the target network entity may perform aspects of the described functions using special-purpose hardware.

At 1605, the method may include obtaining a request for one or more random access resources associated with a candidate cell served by the target network entity. The operations of 1605 may be performed in accordance with examples as disclosed herein, such as at 605 of FIG. 6. In some examples, aspects of the operations of 1605 may be performed by a cell manager 925 as described with reference to FIG. 9.

At 1610, the method may include outputting a random access resource configuration indicating the one or more random access resources and the candidate cell based on the request, where the one or more random access resources are associated with a partition at a source network entity. The operations of 1610 may be performed in accordance with examples as disclosed herein, such as at 615 of FIG. 6. In some examples, aspects of the operations of 1610 may be performed by a resource manager 930 as described with reference to FIG. 9.

At 1615, the method may include obtaining a random access message via one of the one or more random access resources indicated by the random access resource configuration. The operations of 1615 may be performed in accordance with examples as disclosed herein, such as at 630 of FIG. 6. In some examples, aspects of the operations of 1615 may be performed by a mobility manager 935 as described with reference to FIG. 9.

At 1620, the method may include performing a mobility procedure of a UE from the source network entity to the target network entity in response to obtaining the random access message. The operations of 1620 may be performed in accordance with examples as disclosed herein, such as at 645 of FIG. 6. In some examples, aspects of the operations of 1620 may be performed by a mobility manager 935 as described with reference to FIG. 9.

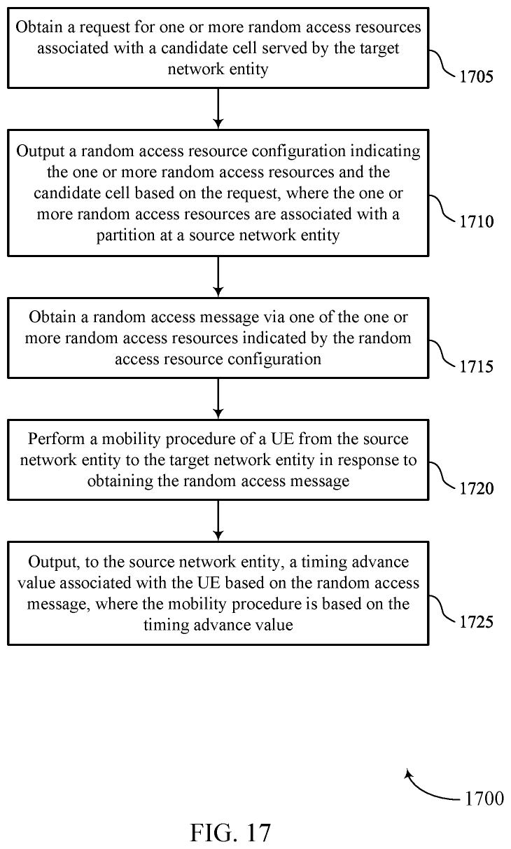

FIG. 17 shows a flowchart illustrating a method 1700 that supports early TA acquisition for mobility procedures in accordance with one or more aspects of the present disclosure. The operations of the method 1700 may be implemented by a target network entity or its components as described herein (e.g., a target network entity 105 as described with reference to FIG. 3-6). For example, the operations of the method 1700 may be performed by a target network entity as described with reference to FIGS. 1 through 10. In some examples, a target network entity may execute a set of instructions to control the functional elements of the target network entity to perform the described functions. Additionally, or alternatively, the target network entity may perform aspects of the described functions using special-purpose hardware.

At 1705, the method may include obtaining a request for one or more random access resources associated with a candidate cell served by the target network entity. The operations of 1705 may be performed in accordance with examples as disclosed herein, such as at 605 of FIG. 6. In some examples, aspects of the operations of 1705 may be performed by a cell manager 925 as described with reference to FIG. 9.

At 1710, the method may include outputting a random access resource configuration indicating the one or more random access resources and the candidate cell based on the request, where the one or more random access resources are associated with a partition at a source network entity. The operations of 1710 may be performed in accordance with examples as disclosed herein, such as at 615 of FIG. 6. In some examples, aspects of the operations of 1710 may be performed by a resource manager 930 as described with reference to FIG. 9.

At 1715, the method may include obtaining a random access message via one of the one or more random access resources indicated by the random access resource configuration. The operations of 1715 may be performed in accordance with examples as disclosed herein, such as at 630 of FIG. 6. In some examples, aspects of the operations of 1715 may be performed by a mobility manager 935 as described with reference to FIG. 9.

At 1720, the method may include performing a mobility procedure of a UE from the source network entity to the target network entity in response to obtaining the random access message. The operations of 1720 may be performed in accordance with examples as disclosed herein, such as at 645 of FIG. 6. In some examples, aspects of the operations of 1720 may be performed by a mobility manager 935 as described with reference to FIG. 9.

At 1725, the method may include outputting, to the source network entity, a TA value associated with the UE based on the random access message, where the mobility procedure is based on the TA value. The operations of 1725 may be performed in accordance with examples as disclosed herein, such as at 635 of FIG. 6. In some examples, aspects of the operations of 1725 may be performed by a TA manager 950 as described with reference to FIG. 9.

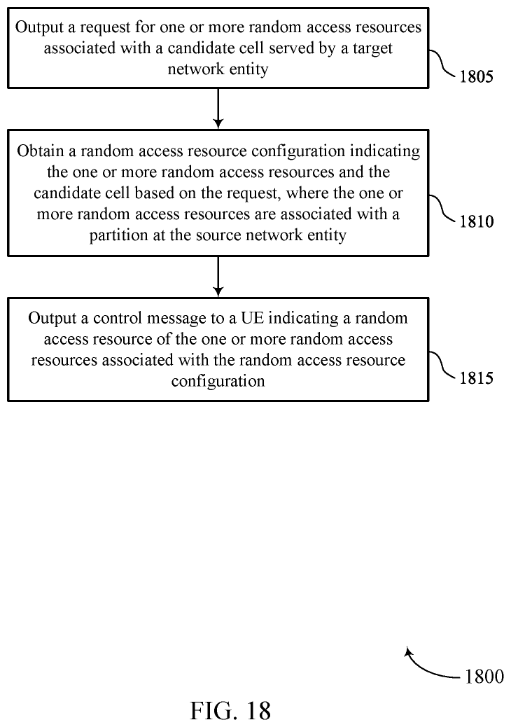

FIG. 18 shows a flowchart illustrating a method 1800 that supports early TA acquisition for mobility procedures in accordance with one or more aspects of the present disclosure. The operations of the method 1800 may be implemented by a source network entity or its components as described herein (e.g., a target network entity 105 as described with reference to FIG. 3-6). For example, the operations of the method 1800 may be performed by a source network entity as described with reference to FIGS. 1 through 6 and 11 through 14. In some examples, a source network entity may execute a set of instructions to control the functional elements of the source network entity to perform the described functions. Additionally, or alternatively, the source network entity may perform aspects of the described functions using special-purpose hardware.

At 1805, the method may include outputting a request for one or more random access resources associated with a candidate cell served by a target network entity. The operations of 1805 may be performed in accordance with examples as disclosed herein, such as at 605 of FIG. 6. In some examples, aspects of the operations of 1805 may be performed by a cell manager 1325 as described with reference to FIG. 13.

At 1810, the method may include obtaining a random access resource configuration indicating the one or more random access resources and the candidate cell based on the request, where the one or more random access resources are associated with a partition at the source network entity. The operations of 1810 may be performed in accordance with examples as disclosed herein, such as at 615 of FIG. 6. In some examples, aspects of the operations of 1810 may be performed by a resource manager 1330 as described with reference to FIG. 13.

At 1815, the method may include outputting a control message to a UE indicating a random access resource of the one or more random access resources associated with the random access resource configuration. The operations of 1815 may be performed in accordance with examples as disclosed herein, such as at 625 of FIG. 6. In some examples, aspects of the operations of 1815 may be performed by a mobility manager 1335 as described with reference to FIG. 13.

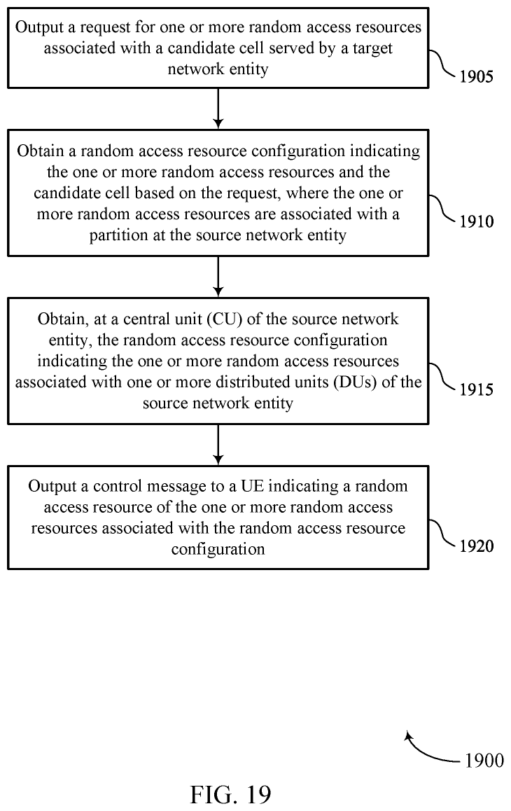

FIG. 19 shows a flowchart illustrating a method 1900 that supports early TA acquisition for mobility procedures in accordance with one or more aspects of the present disclosure. The operations of the method 1900 may be implemented by a source network entity or its components as described herein (e.g., a target network entity 105 as described with reference to FIG. 3-6). For example, the operations of the method 1900 may be performed by a source network entity as described with reference to FIGS. 1 through 6 and 11 through 14. In some examples, a source network entity may execute a set of instructions to control the functional elements of the source network entity to perform the described functions. Additionally, or alternatively, the source network entity may perform aspects of the described functions using special-purpose hardware.

At 1905, the method may include outputting a request for one or more random access resources associated with a candidate cell served by a target network entity. The operations of 1905 may be performed in accordance with examples as disclosed herein, such as at 605 of FIG. 6. In some examples, aspects of the operations of 1905 may be performed by a cell manager 1325 as described with reference to FIG. 13.

At 1910, the method may include obtaining a random access resource configuration indicating the one or more random access resources and the candidate cell based on the request, where the one or more random access resources are associated with a partition at the source network entity. The operations of 1910 may be performed in accordance with examples as disclosed herein, such as at 615 of FIG. 6. In some examples, aspects of the operations of 1910 may be performed by a resource manager 1330 as described with reference to FIG. 13.

At 1915, the method may include obtaining, at a CU of the source network entity, the random access resource configuration indicating the one or more random access resources associated with one or more DUs of the source network entity. The operations of 1915 may be performed in accordance with examples as disclosed herein, such as at 530 of FIG. 5. In some examples, aspects of the operations of 1915 may be performed by a CU manager 1340 as described with reference to FIG. 13.

At 1920, the method may include outputting a control message to a UE indicating a random access resource of the one or more random access resources associated with the random access resource configuration. The operations of 1920 may be performed in accordance with examples as disclosed herein, such as at 625 of FIG. 6. In some examples, aspects of the operations of 1920 may be performed by a mobility manager 1335 as described with reference to FIG. 13.

The following provides an overview of aspects of the present disclosure:
Aspect 1: A method for wireless communication at a target network entity, comprising: obtaining a request for one or more random access resources associated with a candidate cell served by the target network entity; outputting a random access resource configuration indicating the one or more random access resources and the candidate cell based at least in part on the request, wherein the one or more random access resources are associated with a partition at a source network entity; and obtaining a random access message via one of the one or more random access resources indicated by the random access resource configuration.
Aspect 2: The method of aspect 1, further comprising: performing a mobility procedure of a UE from the source network entity to the target network entity in response to obtaining the random access message.
Aspect 3: The method of aspect 2, further comprising: output, to the source network entity, a TA value associating with the UE based at least in part on the random access message, wherein the mobility procedure is based at least in part on the TA value.
Aspect 4: The method of any of aspects 1 through 3, wherein the random access resource configuration comprises a UE identifier, a candidate cell identifier associated with the candidate cell, LTM candidate configuration information, a mobility command, or a combination thereof.
Aspect 5: The method of any of aspects 1 through 4, wherein obtaining the request for one or more random access resources further comprises: obtaining, at a CU of the target network entity, the request for the one or more random access resources.
Aspect 6: The method of aspect 5, further comprising: output, by the CU of the target network entity, a second request for one or more random access resources associating with one or more DUs of the target network entity to the one or more DUs of the target network entity based at least in part on the request for one or more random access resources, wherein the second request comprises an identifier associated with the source network entity, an identifier associated with a DU associated with the source network entity an identifier associated with a cell served by the source network entity, a virtual identifier corresponding to a virtual DU associated with the source network entity, or a combination thereof.
Aspect 7: The method of aspect 6, further comprising: obtaining, from the one or more DUs by the CU of the target network entity, an indication of the random access resource configuration based at least in part on outputting the second request to the one or more DUs of the target network entity, wherein outputting the random access resource configuration comprises outputting, by the CU of the target network entity, the random access resource configuration indicating the one or more random access resources associated with the one or more DUs based at least in part on obtaining the random access resource configuration from the one or more DUs.
Aspect 8: The method of aspect 7, wherein the indication of the random access resource configuration obtain from the one or more DUs comprises, an identifier associated with the source network entity, a DU identifier associated with the source network entity, an identifier associated with a cell served by the source network entity, a virtual identifier corresponding to a virtual DU associated with the source network entity, or a combination thereof.
Aspect 9: The method of any of aspects 1 through 8, wherein obtaining the random access message further comprises: obtaining, at one or more DUs of the target network entity, the random access message via one of the one or more random access resources indicated by the random access resource configuration.
Aspect 10: The method of aspect 9, further comprising: output, by the one or more DUs to a CU of the target network entity, an indication of a TA value corresponding to the random access message, the indication of the TA value comprising an ID associated with the source network entity, a DU identifier associated with the source network entity, an identifier associated with a cell served by the source network entity, a network entity identifier indicated in the request for the one or more random access resources, or a combination thereof.
Aspect 11: The method of any of aspects 1 through 10, wherein, a message comprising the random access resource configuration comprises: a list of one or more cell identifiers, a set of random access resources comprise the one or more random access resources, a user identifier, a cell identifier associated with the target network entity, an LTM candidate configuration, a handover command, a list of DU identifiers corresponding to DUs corresponding to the source network entity, a list of cell identifiers corresponding to cells served by the source network entity, or any combination thereof.
Aspect 12: The method of aspect 11, wherein the message comprising the random access resource configuration further comprises an indication of an association between the set of random access resources and a respective cell identifier of the list of cell identifiers or respective DU identifier of the list of DU identifiers.
Aspect 13: The method of any of aspects 1 through 12, further comprising: partitioning the one or more random access resources into a first set of random access resources and a second set of random access resources, wherein the random access resource configuration comprises an indication of the partitioning at the target network entity, and wherein the first set of random access resources comprises a first set of one or more random access preambles, and the second set of random access resources comprises a second set of one or more random access preambles.
Aspect 14: The method of any of aspects 1 through 12, further comprising: partitioning the one or more random access resources into a first set of random access resources and a second set of random access resources, wherein the random access resource configuration comprises an indication of the partitioning at the target network entity, and wherein the first set of random access resources comprises a first set of one or more ROs, and the second set of random access resources comprises a second set of one or more ROs.
Aspect 15: The method of any of aspects 1 through 14, wherein the request comprises an indication that the one or more random access resources correspond to an uplink synchronization procedure between a UE served by the source network entity and the candidate cell served by the target network entity, the synchronization procedure to occur prior to triggering a mobility procedure of the UE from the source network entity to the target network entity.
Aspect 16: A method for wireless communication at a source network entity, comprising: outputting a request for one or more random access resources associated with a candidate cell served by a target network entity; obtaining a random access resource configuration indicating the one or more random access resources and the candidate cell based at least in part on the request, wherein the one or more random access resources are associated with a partition at the source network entity; and outputting a control message to a UE indicating a random access resource of the one or more random access resources associated with the random access resource configuration.
Aspect 17: The method of aspect 16, wherein obtaining the random access resource configuration further comprises: obtaining, at a CU of the source network entity, the random access resource configuration indicating the one or more random access resources associated with one or more DUs of the source network entity.
Aspect 18: The method of aspect 17, further comprising: output, by the CU of the source network entity to a DU of one or more DUs of the source network entity, a second random access resource configuration indicating a set of one or more random access resources associated with the DU.
Aspect 19: The method of any of aspects 16 through 18, further comprising: obtaining, at a CU of the source network entity from a CU of the target network entity, an indication of a TA value corresponding to a random access message transmitted by the UE and an indication of a random access resource associated with the random access message, wherein the UE is served by a DU of the source network entity; and output, by the CU of the source network entity to the DU of the source network entity, the TA value based at least in part on the random access resource being associated with the DU of the source network entity, wherein a mobility procedure is based at least in part on the TA value.
Aspect 20: A target network entity for wireless communication, comprising one or more memories storing processor-executable code, and one or more processors coupled with the one or more memories and individually or collectively operable to execute the code to cause the target network entity to perform a method of any of aspects 1 through 15.
Aspect 21: A target network entity for wireless communication, comprising at least one means for performing a method of any of aspects 1 through 15.
Aspect 22: A non-transitory computer-readable medium storing code for wireless communication, the code comprising instructions executable by one or more processors to perform a method of any of aspects 1 through 15.
Aspect 23: A source network entity for wireless communication, comprising one or more memories storing processor-executable code, and one or more processors coupled with the one or more memories and individually or collectively operable to execute the code to cause the source network entity to perform a method of any of aspects 16 through 19.
Aspect 24: A source network entity for wireless communication, comprising at least one means for performing a method of any of aspects 16 through 19.
Aspect 25: A non-transitory computer-readable medium storing code for wireless communication, the code comprising instructions executable by one or more processors to perform a method of any of aspects 16 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A target network entity, comprising:
one or more memories storing processor-executable code; and
one or more processors coupled with the one or more memories and individually or collectively operable to execute the code to cause the target network entity to:
obtain a request for one or more random access resources associated with a candidate cell served by the target network entity;
output a random access resource configuration indicating the one or more random access resources and the candidate cell based at least in part on the request, wherein the one or more random access resources are associated with a partition at a source network entity; and
obtain a random access message via one of the one or more random access resources indicated by the random access resource configuration.

2. The target network entity of claim 1, wherein the one or more processors are individually or collectively further operable to execute the code to cause the target network entity to:
perform a mobility procedure of a user equipment (UE) from the source network entity to the target network entity in response to obtaining the random access message.

3. The target network entity of claim 2, wherein the one or more processors are individually or collectively further operable to execute the code to cause the target network entity to:
output, to the source network entity, a timing advance value associated with the UE based at least in part on the random access message, wherein the mobility procedure is based at least in part on the timing advance value.

4. The target network entity of claim 1, wherein the random access resource configuration comprises a UE identifier, a candidate cell identifier associated with the candidate cell, lower layer trigger mobility candidate configuration information, a mobility command, or a combination thereof.

5. The target network entity of claim 1, wherein, to obtain the request for one or more random access resources, the one or more processors are individually or collectively further operable to execute the code to cause the target network entity to:
obtain, at a central unit (CU) of the target network entity, the request for the one or more random access resources.

6. The target network entity of claim 5, wherein the one or more processors are individually or collectively further operable to execute the code to cause the target network entity to:
output, by the CU of the target network entity, a second request for one or more random access resources associated with one or more distributed units (DUs) of the target network entity to the one or more DUs of the target network entity based at least in part on the request for one or more random access resources, wherein the second request comprises an identifier associated with the source network entity, an identifier associated with a DU associated with the source network entity an identifier associated with a cell served by the source network entity, a virtual identifier corresponding to a virtual DU associated with the source network entity, or a combination thereof.

7. The target network entity of claim 6, wherein the one or more processors are individually or collectively further operable to execute the code to cause the target network entity to:
obtain, from the one or more DUs by the CU of the target network entity, an indication of the random access resource configuration based at least in part on outputting the second request to the one or more DUs of the target network entity, wherein outputting the random access resource configuration comprises outputting, by the CU of the target network entity, the random access resource configuration indicating the one or more random access resources associated with the one or more DUs based at least in part on obtaining the random access resource configuration from the one or more DUs.

8. The target network entity of claim 7, wherein the indication of the random access resource configuration obtain from the one or more DUs comprises, an identifier associated with the source network entity, a DU identifier associated with the source network entity, an identifier associated with a cell served by the source network entity, a virtual identifier corresponding to a virtual DU associated with the source network entity, or a combination thereof.

9. The target network entity of claim 1, wherein, to obtain the random access message, the one or more processors are individually or collectively further operable to execute the code to cause the target network entity to:
obtain, at one or more DUs of the target network entity, the random access message via one of the one or more random access resources indicated by the random access resource configuration.

10. The target network entity of claim 9, wherein the one or more processors are individually or collectively further operable to execute the code to cause the target network entity to:
output, by the one or more DUs to a CU of the target network entity, an indication of a timing advance value corresponding to the random access message, the indication of the timing advance value comprising an ID associated with the source network entity, a DU identifier associated with the source network entity, an identifier associated with a cell served by the source network entity, a network entity identifier indicated in the request for the one or more random access resources, or a combination thereof.

11. The target network entity of claim 1, wherein a message comprising the random access resource configuration comprises:
a list of one or more cell identifiers, a set of random access resources comprise the one or more random access resources, a user identifier, a cell identifier associated with the target network entity, an LTM candidate configuration, a handover command, a list of DU identifiers corresponding to DUs corresponding to the source network entity, a list of cell identifiers corresponding to cells served by the source network entity, or any combination thereof.

12. The target network entity of claim 11, wherein the message comprising the random access resource configuration further comprises an indication of an association between the set of random access resources and a respective cell identifier of the list of cell identifiers or respective DU identifier of the list of DU identifiers.

13. The target network entity of claim 1, wherein the one or more processors are individually or collectively further operable to execute the code to cause the target network entity to:
partition the one or more random access resources into a first set of random access resources and a second set of random access resources, wherein the random access resource configuration comprises an indication of the partitioning at the target network entity, and wherein the first set of random access resources comprises a first set of one or more random access preambles, and the second set of random access resources comprises a second set of one or more random access preambles.

14. The target network entity of claim 1, wherein the one or more processors are individually or collectively further operable to execute the code to cause the target network entity to:
partition the one or more random access resources into a first set of random access resources and a second set of random access resources, wherein the random access resource configuration comprises an indication of the partitioning at the target network entity, and wherein the first set of random access resources comprises a first set of one or more random access occasions, and the second set of random access resources comprises a second set of one or more random access occasions.

15. The target network entity of claim 1, wherein the request comprises an indication that the one or more random access resources correspond to an uplink synchronization procedure between a UE served by the source network entity and the candidate cell served by the target network entity, the synchronization procedure to occur prior to triggering a mobility procedure of the UE from the source network entity to the target network entity.

16. A source network entity, comprising:
one or more memories storing processor-executable code; and
one or more processors coupled with the one or more memories and individually or collectively operable to execute the code to cause the source network entity to:
output a request for one or more random access resources associated with a candidate cell served by a target network entity;
obtain a random access resource configuration indicating the one or more random access resources and the candidate cell based at least in part on the request, wherein the one or more random access resources are associated with a partition at the source network entity; and
output a control message to a user equipment (UE) indicating a random access resource of the one or more random access resources associated with the random access resource configuration.

17. The source network entity of claim 16, wherein, to obtain the random access resource configuration, the one or more processors are individually or collectively further operable to execute the code to cause the source network entity to:
obtain, at a central unit (CU) of the source network entity, the random access resource configuration indicating the one or more random access resources associated with one or more distributed units (DUs) of the source network entity.

18. The source network entity of claim 17, wherein the one or more processors are individually or collectively further operable to execute the code to cause the source network entity to:
output, by the CU of the source network entity to a DU of one or more DUs of the source network entity, a second random access resource configuration indicating a set of one or more random access resources associated with the DU.

19. The source network entity of claim 16, wherein the one or more processors are individually or collectively further operable to execute the code to cause the source network entity to:
obtain, at a CU of the source network entity from a CU of the target network entity, an indication of a timing advance value corresponding to a random access message transmitted by the UE and an indication of a random access resource associated with the random access message, wherein the UE is served by a DU of the source network entity; and
output, by the CU of the source network entity to the DU of the source network entity, the timing advance value based at least in part on the random access resource being associated with the DU of the source network entity, wherein a mobility procedure is based at least in part on the timing advance value.

20. A method for wireless communication at a target network entity, comprising:
obtaining a request for one or more random access resources associated with a candidate cell served by the target network entity;
outputting a random access resource configuration indicating the one or more random access resources and the candidate cell based at least in part on the request, wherein the one or more random access resources are associated with a partition at a source network entity; and
obtaining a random access message via one of the one or more random access resources indicated by the random access resource configuration.
